(19) United States
(12) Patent Application Publication
(10) Pub. No.: US 2019/0359841 A1
(43) Pub. Date: Nov. 28, 2019

(54) OPTICAL SHAPING INK SET, OPTICALLY SHAPED ARTICLE, AND METHOD FOR PRODUCING OPTICALLY SHAPED ARTICLE

(71) Applicant: Maxell Holdings, Ltd., Kyoto (JP)

(72) Inventors: Katsuyuki KITO, Kyoto (JP); Taeko IZUMO, Kyoto (JP)

(21) Appl. No.: 16/476,734

(22) PCT Filed: Jan. 31, 2018
(86) PCT No.: PCT/JP2018/003269

§ 371 Date: Jul. 9, 2019

(30) Foreign Application Priority Data
Jan. 31, 2017 (JP) 2017-016122
Jan. 31, 2017 (JP) 2017-016126

(51) Int. Cl. C09D 11/40; C09D 11/38; C09D 11/36; C09D 11/101; C09D 11/107; C09D 11/033; B33Y 10/00; B33Y 70/00; B29C 64/112; B29C 64/40

(52) U.S. Cl. CPC C09D 11/40; C09D 11/38; C09D 11/36; C09D 11/101; C09D 11/107; B33Y 80/00; B33Y 10/00; B33Y 70/00; B29C 64/112; B29C 64/40; C09D 11/033

(57) ABSTRACT

The present invention relates to an optical shaping ink set in which a composition for model material comprises a monofunctional ethylenically unsaturated monomer (A) and a polyfunctional ethylenically unsaturated monomer (B), at least either of the monomer (A) or (B) has a hydroxyl group or an amino group, a total molar fraction of the hydroxyl group and the amino group is 5% to 30% with respect to a total amount of the monomer (A) and (B), or the composition for model material contains an ethylenically unsaturated monomer (C) of which a homopolymer has a Tg of 25° C. to 120° C., an ethylenically unsaturated monomer (D) of which a homopolymer has a Tg of −65° C. to 25° C., a bifunctional acrylate oligomer (E) having a Mw of 800 to 10,000, and an acylphosphine oxide compound, and a content of a bi- or higher functional acrylate compound is 15 to 100 parts by weight, and a composition for support material contains a water-soluble monofunctional ethylenically unsaturated monomer (a), a polyalkylene glycol (b) containing an oxyethylene group and/or an oxypropylene group, a water-soluble organic solvent (c), and a photopolymerization initiator (d).

### TECHNICAL FIELD

The present application is filed, claiming the Paris Convention priorities based on the Japanese Patent Application No. 2017-016122 (filing date: Jan. 31, 2017) and Japanese Patent Application No. 2017-016126 (filing date: Jan. 31, 2017), and a whole of the contents of these applications is incorporated herein by reference.

The present invention relates to an optical shaping ink set (an ink set for stereolithography) used in an inkjet optical shaping method (inkjet stereolithography), an optically shaped article shaped using the optical shaping ink set, and a method for producing an optically shaped article (a stereolithographic article) using the optical shaping ink set.

### BACKGROUND ART

Conventionally, as a method for producing a three-dimensional shaped object, a shaping method using a photocurable composition that is cured by being irradiated with ultraviolet light and the like has been widely known. Specifically, in such a shaping method, a photocurable composition is irradiated with ultraviolet light and thus cured to form a cured layer having a predetermined shape. Thereafter, a photocurable composition is further supplied onto the cured layer and cured to form a new cured layer. The above-mentioned steps are repeatedly performed to obtain a three-dimensional shaped object.

Among the above-mentioned shaping methods, in recent years there has been reported an inkjet optical shaping method in which a photocurable composition is discharged from a nozzle, irradiated with ultraviolet light and the like immediately thereafter, and thus cured to form a cured layer having a predetermined shape (hereinafter referred to as inkjet optical shaping method) (Patent Documents 1 to 6). The inkjet optical shaping method does not require the installation of a large resin liquid tank for storing the photocurable composition and a dark room. For this reason, the shaping apparatus can be further miniaturized as compared with that in the conventional method. The inkjet optical shaping method has attracted attention as a shaping method to be realized by a 3D printer which can freely make a three-dimensional shaped object based on CAD (Computer Aided Design) data.

In the inkjet optical shaping method, in the case of shaping an optically shaped article having a complicated shape such as a hollow shape, the optically shaped article is formed by using a model material in combination with a support material in order to support the model material (Patent Documents 1, 2, and 4 to 6). The support material is formed by irradiating a photocurable composition with ultraviolet light and the like and thus curing the photocurable composition in the same manner as the forming of model material. After forming the model material, the support material can be removed by being physically peeled off or dissolved in an organic solvent or water.

In recent years, there has been a demand for shaping an optically shaped article which exhibits rubber-like elongation and elasticity and an optically shaped article which is soft and excellent in tensile strength using stereolithography by an inkjet method, and various compositions for model material have been proposed. For example, Patent Document 5 discloses that an optically shaped article which exhibits rubber-like elongation and elasticity is obtained when an ink composition is cured, as the total molar fraction of the hydroxyl group and/or amino group belonging to the monofunctional monomer and polyfunctional monomer contained in the ink composition is adjusted to a range of 5% to 30%. In addition, Patent Document 6 discloses that a cured product obtained by photocuring an ink composition is soft and excellent in tensile strength as the ink composition contains an acrylate monomer A of which the homopolymer has a glass transition temperature of 25° C. or higher and 120° C. or lower, an acrylate monomer B of which the homopolymer has a glass transition temperature of −60° C. or higher and lower than 25° C., a bifunctional acrylate oligomer C having a weight average molecular weight of 2,000 or more and 20,000 or less, and an acylphosphine oxide compound as a photopolymerization initiator and the content of a bi- or higher functional acrylate compound with respect to the total amount of the ink composition is regulated to be in a specific range.

### PRIOR ART DOCUMENT

### Patent Documents

Patent Document 1: JP-A-2004-255839

Patent Document 2: JP-A-2010-155889

Patent Document 3: JP-A-2010-155926

Patent Document 4: JP-A-2012-111226

Patent Document 5: WO 2015/049873

Patent Document 6: WO 2016/098636

### SUMMARY OF THE INVENTION

### Problems to be Solved by the Invention

Patent Document 5 describes that a composition containing a water-soluble ethylenically polymerizable compound, a water-soluble polymer, a photocleavable initiator, and water as main components can be used as an example of the composition for support material which can be used when forming a model material. In addition, Patent Document 6 discloses a composition containing a monofunctional acrylamide compound and/or a monofunctional acrylate compound having one or more hydroxyl groups, polyethylene glycol and/or polypropylene glycol, and a photopolymerization initiator as an example of the composition for support material. However, even if such a composition for support material is used, the support material obtained by photocuring the composition for support material may be inferior in the self-standing ability depending on the kinds and contents of the components which the composition for support material comprises. As a result, there has been a problem that the dimensional accuracy of the optically shaped article shaped using the composition for support material decreases.

The present invention has been made in view of the present situation, and an object thereof is to provide an optical shaping ink set from which it is possible to obtain an optically shaped article having high dimensional accuracy even in combination with a model material which exhibits rubber-like elongation and elasticity or is soft and thus has dimensional accuracy to relatively easily decrease, and as a result, to obtain an optically shaped article which has good dimensional accuracy and exhibits rubber-like elongation and elasticity or an optically shaped article which has good dimensional accuracy and is soft and excellent in tensile strength. In addition, an object of the present invention is to provide an optically shaped article shaped using the optical shaping ink set and a method for producing an optically shaped article using the optical shaping ink set.

### Solutions to the Problems

The present inventors have found out that a support material exhibiting excellent self-standing ability is obtained by regulating the content of a nonpolymerizable component and the content of a water-soluble monofunctional ethylenically unsaturated monomer in a composition for support material in predetermined ranges. Moreover, the present inventors have found out that it is possible to mold an optically shaped article having good dimensional accuracy by use of the composition for support material even in the case of forming a relatively soft or elastic model material.

The present invention has been achieved based on the above findings and includes the following suitable aspects.

[1] An optical shaping ink set, which is used in an inkjet optical shaping method, comprising a composition for model material used for shaping a model material in combination with a composition for support material used for shaping a support material,

wherein

the composition for model material comprises a monofunctional ethylenically unsaturated monomer (A) and a polyfunctional ethylenically unsaturated monomer (B),

at least either of the monofunctional ethylenically unsaturated monomer (A) or the polyfunctional ethylenically unsaturated monomer (B) has a hydroxyl group or an amino group,

a total molar fraction of the hydroxyl group and the amino group is 5% to 30% with respect to a total amount of the monofunctional ethylenically unsaturated monomer (A) and the polyfunctional ethylenically unsaturated monomer (B), and

the composition for support material comprises, with respect to 100 parts by weight of the total amount of the composition for support material,
a water-soluble monofunctional ethylenically unsaturated monomer (a) at 20 to 50 parts by weight,
a polyalkylene glycol (b) containing an oxyethylene group and/or an oxypropylene group at 20 to 49 parts by weight,
a water-soluble organic solvent (c) at 35 parts by weight or less, and
a photopolymerization initiator (d).
   [2] The optical shaping ink set according to [1], wherein, in the composition for model material, a molar fraction of the monofunctional ethylenically unsaturated monomer (A) to the polyfunctional ethylenically unsaturated monomer (B) (monofunctional ethylenically unsaturated monomer (A)/polyfunctional ethylenically unsaturated monomer (B)) is 92/8 to 99.9/0.1.
   [3] The optical shaping ink set according to [1] or [2], wherein, in the composition for model material, at least either of the monofunctional ethylenically unsaturated monomer (A) or the polyfunctional ethylenically unsaturated monomer (B) has one or more selected from an amide bond, a urea bond, and a urethane bond.
   [4] The optical shaping ink set according to any one of [1] to [3], wherein, in the composition for model material, the monofunctional ethylenically unsaturated monomer (A) contains a monofunctional ethylenically unsaturated monomer (A1) having a hydroxyl group or an amino group, and the monofunctional ethylenically unsaturated monomer (A1) has a molecular weight of 200 to 1,000.
   [5] The optical shaping ink set according to any one of [1] to [4], wherein, in the composition for model material, the polyfunctional ethylenically unsaturated monomer (B) contains a polyfunctional ethylenically unsaturated monomer (B1) having a hydroxyl group or an amino group, and the polyfunctional ethylenically unsaturated monomer (B1) has a molecular weight of 200 to 1,000.
   [6] An optical shaping ink set, which is used in an inkjet optical shaping method, comprising a composition for model material used for shaping a model material in combination with a composition for support material used for shaping a support material,

wherein

the composition for model material comprises:
an ethylenically unsaturated monomer (C) of which a homopolymer has a glass transition temperature of 25° C. or higher and 120° C. or lower,
an ethylenically unsaturated monomer (D) of which a homopolymer has a glass transition temperature of −65° C. or higher and lower than 25° C.,
a bifunctional acrylate oligomer (E) having a weight average molecular weight of 800 or more and 10,000 or less, and
an acylphosphine oxide compound, and

a content of a bi- or higher functional acrylate compound is 15 parts by weight or less with respect to 100 parts by weight of the total amount of the composition for model material, and

the composition for support material comprises, with respect to 100 parts by weight of the total amount of the composition for support material,
a water-soluble monofunctional ethylenically unsaturated monomer (a) at 20 to 50 parts by weight,
a polyalkylene glycol (b) containing an oxyethylene group and/or an oxypropylene group at 20 to 49 parts by weight,
a water-soluble organic solvent (c) at 35 parts by weight or less, and
a photopolymerization initiator (d).
   [7] The optical shaping ink set according to [6], wherein, in the composition for model material, the ethylenically unsaturated monomer (C) is a monofunctional ethylenically unsaturated monomer.
   [8] The optical shaping ink set according to [6] or [7], wherein, in the composition for model material, the ethylenically unsaturated monomer (D) is a monofunctional ethylenically unsaturated monomer.
   [9] The optical shaping ink set according to any one of [6] to [8], wherein, in the composition for model material, the bifunctional acrylate oligomer (E) has a Young's modulus at 25° C. of 1 to 100 MPa.
   [10] The optical shaping ink set according to any one of [6] to [9], wherein a content of the bifunctional acrylate oligomer (E) in the composition for model material is 1 to 15 parts by weight with respect to 100 parts by weight of the total amount of the composition for model material.
   [11] The optical shaping ink set according to any one of [6] to [10], wherein, in the composition for model material, the ethylenically unsaturated monomer (C) is one or more selected from isobornyl acrylate, t-butylcyclohexyl acrylate, 3,3,5-trimethylcyclohexyl acrylate, and dicyclopentanyl acrylate.
   [12] The optical shaping ink set according to any one of [6] to [11], wherein, in the composition for model material, the ethylenically unsaturated monomer (D) is one or more selected from phenoxyethyl acrylate, n-stearyl acrylate, isodecyl acrylate, ethoxyethoxyethyl acrylate, tetrahydrofurfuryl acrylate, n-lauryl acrylate, n-octyl acrylate, n-decyl acrylate, isooctyl acrylate, n-tridecyl acrylate, and 2-(N-butylcarbamoyloxy)ethyl acrylate.
   [13] The optical shaping ink set according to any one of [1] to [12], wherein a content of the water-soluble monofunctional ethylenically unsaturated monomer (a) in the composition for support material is 25 to 45 parts by weight with respect to 100 parts by weight of the total amount of the composition for support material.
   [14] The optical shaping ink set according to any one of [1] to [13], wherein a content of the polyalkylene glycol (b) in the composition for support material is 25 to 45 parts by weight with respect to 100 parts by weight of the total amount of the composition for support material.
   [15] The optical shaping ink set according to any one of [1] to [14], wherein a content of the water-soluble organic solvent (c) in the composition for support material is 5 parts by weight or more with respect to 100 parts by weight of the total amount of the composition for support material.
   [16] The optical shaping ink set according to any one of [1] to [15], wherein a content of the photopolymerization initiator (d) in the composition for support material is 5 to 20 parts by weight with respect to 100 parts by weight of the total amount of the composition for support material.
   [17] The optical shaping ink set according to any one of [1] to [16], wherein the composition for support material further comprises a storage stabilizer (e) at 0.05 to 3.0 parts by weight with respect to 100 parts by weight of the total amount of the composition for support material.
   [18] An optically shaped article shaped by an inkjet optical shaping method using the optical shaping ink set according to any one of [1] to [17].
   [19] A method for producing an optically shaped article by an inkjet optical shaping method using the optical shaping ink set according to any one of [1] to [17], the method comprising:

a step (I) of photocuring the composition for model material to obtain a model material and, at the same time, photocuring the composition for support material to obtain a support material; and

a step (II) of removing the support material.

[20] The method for producing an optically shaped article according to [19], wherein the composition for model material and the composition for support material are photocured using an ultraviolet LED in the step (I).

### Effects of the Invention

According to the present invention, it is possible to provide an optical shaping ink set for obtaining an optically shaped article which has good dimensional accuracy and exhibits rubber-like elongation and elasticity or an optically shaped article which has good dimensional accuracy and is soft and excellent in tensile strength, an optically shaped article shaped using the optical shaping ink set, and a method for producing an optically shaped article using the optical shaping ink set.

### BRIEF DESCRIPTION OF THE DRAWINGS

FIG. 1 is a diagram schematically illustrating a step (I) in a method for producing an optically shaped article according to the present embodiment.

FIG. 2 is a diagram schematically illustrating a step (II) in a method for producing an optically shaped article according to the present embodiment.

FIG. 3(a) is a top view of a cured product obtained using each composition for model material and each composition for support material shown in Table 3.

FIG. 3(b) is a cross-sectional view taken along the line A-A in FIG. 3(a).

### EMBODIMENTS OF THE INVENTION

Hereinafter, an embodiment of the present invention (hereinafter also referred to as the present embodiment) will be described in detail. The present invention is not limited to the following contents. Incidentally, in the following description, the term “(meth)acrylate” is a generic term for an acrylate and a methacrylate and means either or both of an acrylate and a methacrylate. The same applies to the terms of “(meth)acryloyl” and “(meth)acrylic”.

1. Composition for Model Material

In an embodiment of the present invention, a composition for model material constituting the optical shaping ink set of the present invention comprises a monofunctional ethylenically unsaturated monomer (A) and a polyfunctional ethylenically unsaturated monomer (B), in which at least either of the monofunctional ethylenically unsaturated monomer (A) or the polyfunctional ethylenically unsaturated monomer (B) has a hydroxyl group or an amino group, a total molar fraction of the hydroxyl group and the amino group is 5% to 30% with respect to a total amount of the monofunctional ethylenically unsaturated monomer (A) and the polyfunctional ethylenically unsaturated monomer (B). By use of a composition for model material having the constitution, it is possible to form an optically shaped article (model material) which exhibits rubber-like elongation and elasticity.

Hereinafter, an embodiment including the composition for model material (hereinafter, also referred to as “Embodiment (1) of the present invention”) will be described.

<Monofunctional Ethylenically Unsaturated Monomer (A)>

The composition for model material contained in the optical shaping ink set according to Embodiment (1) of the present invention comprises a monofunctional ethylenically unsaturated monomer (A). The monofunctional ethylenically unsaturated monomer (A) is a polymerizable monomer (monofunctional monomer) having one ethylenic double bond in the molecule and exhibiting the property of being cured by energy rays. Examples of the polymerizable group having one ethylenic double bond include an ethylene group ((meth)acrylic group, vinyl ether group, allyl ether group, styrene group, (meth)acrylamide group, acetyl vinyl group, vinyl amide group or the like) and an acetylene group.

It is preferable that the monofunctional ethylenically unsaturated monomer (A) contains a monofunctional ethylenically unsaturated monomer (A1) having a hydroxyl group or an amino group. Incidentally, the hydroxyl group includes a carboxyl group and the like in addition to an alcoholic hydroxyl group. In addition, the amino group includes an amide bond, a urea bond, a urethane bond and the like in addition to an ordinary amino group.

The monofunctional ethylenically unsaturated monomer having a hydroxyl group (hereinafter, also referred to as “hydroxyl group-containing monofunctional ethylenically unsaturated monomer (A1a)”) may have a hydroxyl group as a carboxyl group or may have a carboxyl group in addition to a hydroxyl group. The monofunctional ethylenically unsaturated monomer having a carboxyl group has both a proton donor and an acceptor. For this reason, polymer chains can be pseudo-crosslinked as the mutual interaction therebetween is enhanced in a case in which the monofunctional ethylenically unsaturated monomer having a carboxyl group is contained in the polymer chain as the hydroxyl group-containing monofunctional ethylenically unsaturated monomer (A1a).

Specific examples of the hydroxyl group-containing monofunctional ethylenically unsaturated monomer (A1a) include alcoholic hydroxyl group-containing monofunctional ethylenically unsaturated monomers such as 2-hydroxyethyl (meth)acrylate and 2-hydroxypropyl (meth)acrylate, 2-hydroxy-3-phenoxypropyl (meth)acrylate, 2-(meth)acryloyloxyethyl-2-hydroxyethyl-phthalic acid, and caprolactone acrylate; and carboxyl group-containing monofunctional ethylenically unsaturated monomers such as 2-(meth)acryloyloxyethyl hexahydrophthalic acid, 2-(meth)acryloyloxyethyl succinic acid, and 2-(meth)acryloyloxyethyl phthalic acid. These may be used singly, or two or more thereof may be used concurrently.

It is preferable that the monofunctional ethylenically unsaturated monomer having an amino group (hereinafter, also referred to as “amino group-containing monofunctional ethylenically unsaturated monomer (A1b)”) has any partial structure represented by the following general formula (i). In other words, it is preferable that the amino group-containing monofunctional ethylenically unsaturated monomer (A1b) has an amide bond, a urea bond, or a urethane bond. In the amino group-containing monofunctional ethylenically unsaturated monomer (A1b) having any partial structure represented by the following general formula (i), two or more polarized moieties are close to each other. For this reason, polymer chains can be pseudo-crosslinked as the mutual interaction therebetween is enhanced in a case in which the amino group-containing monofunctional ethylenically unsaturated monomer (A1b) having such a structure is contained in the polymer chain.

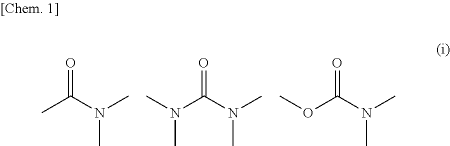

Furthermore, it is more preferable that the amino group-containing monofunctional ethylenically unsaturated monomer (A1b) has any partial structure represented by the following general formula (ii). In other words, it is more preferable that the amino group-containing monofunctional ethylenically unsaturated monomer (A1b) has an amide bond in which a hydrogen atom is bonded to a nitrogen atom, a urea bond in which a hydrogen atom is bonded to a nitrogen atom, and a urethane bond in which a hydrogen atom is bonded to a nitrogen atom. The monofunctional ethylenically unsaturated monomer having any partial structure represented by the following general formula (ii) has both a proton donor and an acceptor. For this reason, polymer chains can be pseudo-crosslinked as the mutual interaction therebetween is enhanced in a case in which the amino group-containing monofunctional ethylenically unsaturated monomer (A1b) having such a structure is contained in the polymer chain.

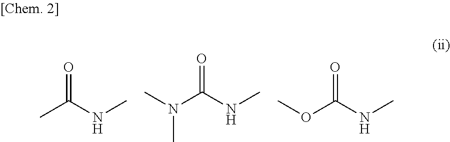

Specific examples of the amino group-containing monofunctional ethylenically unsaturated monomer (A1b) include (meth)acrylamides such as dimethyl acrylamide, acryloyl morpholine, dimethylaminopropyl acrylamide, isopropyl acrylamide, diethyl acrylamide, hydroxyethyl acrylamide, dimethylaminopropyl acrylamide, and hydroxyethyl acrylamide; urethane acrylates such as 2-(butylcarbamoyloxy)ethyl acrylate and a compound represented by the following formula (iii); N-vinylformamide, N-vinylcaprolactam, N-vinylpyrrolidone, dimethylaminoethyl methacrylate, diethylaminoethyl methacrylate, and various amine-modified acrylates. These may be used singly, or two or more thereof may be used concurrently.

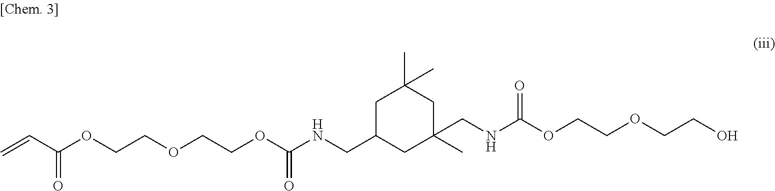 [SMILES: C=CC(=O)OCCOCCOC(=O)NCC1CC(C)(C)CC(C)(CNC(=O)OCCOCCO)C1]

It is preferable that the molecular weight of the monofunctional ethylenically unsaturated monomer (A1) having a hydroxyl group or an amino group is 200 to 1,000, from the viewpoint of adjusting (tending to decrease) the viscosity of the composition for model material and thus improving the discharging stability from the inkjet head.

It is preferable that the glass transition temperature of the cured product obtained by photocuring the monofunctional ethylenically unsaturated monomer (A1) having a hydroxyl group or an amino group is 0° C. or lower from the viewpoint of imparting rubber-like elongation and elasticity to a model material obtained by photocuring the composition for model material.

The monofunctional ethylenically unsaturated monomer (A) may be a monofunctional ethylenically unsaturated monomer (A2) which does not have a hydroxyl group and an amino group in a case in which the polyfunctional ethylenically unsaturated monomer (B) contained in the composition for model material has a hydroxyl group or an amino group. In addition, a monofunctional ethylenically unsaturated monomer (A2) which does not have a hydroxyl group and an amino group may be contained in addition to the monofunctional ethylenically unsaturated monomer (A1) having a hydroxyl group or an amino group. Examples of the monofunctional ethylenically unsaturated monomer (A2) include a monofunctional ethylenically unsaturated monomer having a (meth)acrylic group, a monofunctional ethylenically unsaturated monomer having a vinyl ether group, a monofunctional ethylenically unsaturated monomer having an allyl ether group, and a monofunctional ethylenically unsaturated monomer having an acetylene group. These may be used singly, or two or more thereof may be used concurrently.

Examples of the monofunctional ethylenically unsaturated monomer having a (meth)acrylic group include isoamyl (meth)acrylate, stearyl (meth)acrylate, lauryl (meth)acrylate, octyl (meth)acrylate, decyl (meth)acrylate, isodecyl (meth)acrylate, isomylstil (meth)acrylate, isostearyl (meth)acrylate, 2-ethylhexyl-diglycol (meth)acrylate, 2-hydroxybutyl (meth)acrylate, butoxyethyl (meth)acrylate, ethoxydiethylene glycol (meth)acrylate, methoxy diethylene glycol (meth)acrylate, methoxy polyethylene glycol (meth)acrylate, methoxy propylene glycol (meth)acrylate, phenoxyethyl (meth)acrylate, phenoxy diethylene glycol (meth)acrylate, tetrahydrofurfuryl (meth)acrylate, isobornyl (meth)acrylate, and t-butylcyclohexyl (meth)acrylate.

Examples of the monofunctional ethylenically unsaturated monomer having a vinyl ether group include butyl vinyl ether, butyl propenyl ether, butyl butenyl ether, hexyl vinyl ether, ethyl hexyl vinyl ether, phenyl vinyl ether, benzyl vinyl ether, ethyl ethoxy vinyl ether, acetyl ethoxy ethoxy vinyl ether, cyclohexyl vinyl ether, and adamantyl vinyl ether.

Examples of the monofunctional ethylenically unsaturated monomer having an allyl ether group include phenyl allyl ether, o-, m-, p-cresol monoallyl ether, biphenyl-2-ol monoallyl ether, biphenyl-4-ol monoallyl ether, butyl allyl ether, cyclohexyl allyl ether, and cyclohexane methanol monoallyl ether.

Examples of the monofunctional ethylenically unsaturated monomer having an acetylene group include acetylene.

The monofunctional ethylenically unsaturated monomer (A) may contain a monofunctional (meth)acrylate (X). Examples of the monofunctional (meth)acrylate (X) include a monofunctional (meth)acrylate represented by a general formula (iv) (hereinafter, also referred to as “monofunctional (meth)acrylate (X1)”) and a monofunctional (meth)acrylate (X2) represented by a general formula (v). The monofunctional (meth)acrylate (X1) and the monofunctional (meth)acrylate (hereinafter, also referred to as “monofunctional (meth)acrylate (X2)”) may be the monofunctional ethylenically unsaturated monomers (A1) described above or the monofunctional ethylenically unsaturated monomer (A2) described above.

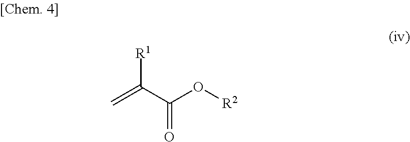

In general formula (iv), R¹ denotes H or CH₃. R² denotes an alkyl group which has 2 to 22 carbon atoms and may be substituted with an aryl group having 6 to 12 carbon atoms, or an aryl group having 6 to 12 carbon atoms.

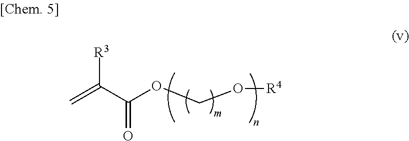

In general formula (v), R³ denotes H or CH₃. R⁴ denotes a monovalent substituent having an alicyclic hydrocarbon or an alkyl group which has 11 to 22 carbon atoms and may be substituted with an aryl group having 6 to 12 carbon atoms. m denotes an integer of 2 to 4. n denotes an integer of 1 or 2.

Examples of the monofunctional (meth)acrylate (X1) include isoamyl (meth)acrylate, lauryl (meth)acrylate, octyl (meth)acrylate, and decyl (meth)acrylate. These may be used singly, or two or more thereof may be used concurrently.

Examples of the monofunctional (meth)acrylate (X2) include methoxy polyethylene glycol (meth)acrylate, methoxy propylene glycol (meth)acrylate, phenoxyethyl (meth)acrylate, phenoxyethoxyethyl (meth)acrylate, isobornyl (meth)acrylate, and dicyclopentanyl (meth)acrylate. These may be used singly, or two or more thereof may be used concurrently.

The total content of the monofunctional (meth)acrylate (X1) and monofunctional (meth)acrylate (X2) contained in the composition for model material is preferably 65 parts by weight or more, more preferably 80 parts by weight or more, and preferably 98 parts by weight or less with respect to 100 parts by weight of the total amount of the monofunctional (meth)acrylate (X). Incidentally, the content is the sum of contents of the respective monofunctional (meth)acrylates in a case in which two or more monofunctional (meth)acrylates (X1) and/or (X2) are contained.

It is preferable that the monofunctional (meth)acrylate (X) has a molecular weight of 160 or more and less than 400 and contains a monofunctional (meth)acrylate (X′) in which the glass transition temperature (hereinafter referred to as Tg) of the cured product obtained by photocuring the monofunctional (meth)acrylate is −20° C. or lower. In the present invention, it is preferable that the monofunctional ethylenically unsaturated monomer (A) contains the monofunctional (meth)acrylate (X′) at 85 parts by weight or more with respect to 100 parts by weight of the total amount of the monofunctional ethylenically unsaturated monomer (A). Incidentally, the monofunctional (meth)acrylate (X′) may be the monofunctional ethylenically unsaturated monomer (A1) described above or the monofunctional ethylenically unsaturated monomer (A2) described above.

Examples of the monofunctional (meth)acrylate (X′) include isoamyl acrylate, lauryl acrylate, octyl acrylate, decyl acrylate, isomylstil acrylate, isostearyl acrylate, 2-ethylhexyl-diglycol acrylate, 2-hydroxybutyl acrylate, butoxyethyl (meth)acrylate, ethoxydiethylene glycol acrylate, methoxy diethylene glycol acrylate, methoxy polyethylene glycol acrylate, methoxy propylene glycol acrylate, phenoxyethyl acrylate, and tetrahydrofurfuryl (meth)acrylate.

### <Polyfunctional Ethylenically Unsaturated Monomer (B)>

The composition for model material contained in the optical shaping ink set according to the present embodiment comprises a polyfunctional ethylenically unsaturated monomer (B). The polyfunctional ethylenically unsaturated monomer (B) is a polymerizable monomer (polyfunctional monomer) having two or more ethylenic double bonds in the molecule and exhibiting the property of being cured by energy rays.

It is preferable that the polyfunctional ethylenically unsaturated monomer (B) has one or more functional groups selected from a (meth)acrylic group, a vinyl ether group, an allyl ether group, a styrene group, and a (meth)acrylamide group in the molecule. Among these, it is more preferable to have one or more functional groups selected from an acrylic group, a methacrylic group, a vinyl ether group, and an allyl ether group since the photopolymerization sensitivity is favorable. It is preferable that the polyfunctional ethylenically unsaturated monomer (B) has two or more functional groups described above and the functional group belonging to the polyfunctional ethylenically unsaturated monomer (B) is selected from the aforementioned functional groups. Incidentally, a plurality of functional groups belonging to one polyfunctional ethylenically unsaturated monomer (B) may be the same as or different from each other.

Examples of the polyfunctional ethylenically unsaturated monomer (B) having an allyl ether group include diallyl phthalate and diallyl isophthalate. Examples of the polyfunctional ethylenically unsaturated monomer (B) having a styrene group include divinylbenzene. Examples of the polyfunctional ethylenically unsaturated monomer (B) having a (meth)acrylamide group include N,N-ethylenebisacrylamide.

The polyfunctional ethylenically unsaturated monomer (B) contains a polyfunctional ethylenically unsaturated monomer (B1) having a hydroxyl group or an amino group in a case in which the monofunctional ethylenically unsaturated monomer (A) does not contain a monofunctional ethylenically unsaturated monomer having a hydroxyl group or an amino group. Incidentally, the hydroxyl group includes a carboxyl group and the like in addition to an alcoholic hydroxyl group. In addition, the amino group includes an amide bond, a urea bond, a urethane bond and the like in addition to an ordinary amino group.

It is preferable that the polyfunctional ethylenically unsaturated monomer having a hydroxyl group (hereinafter also referred to as “hydroxyl group-containing polyfunctional ethylenically unsaturated monomer (B1a)”) has a carboxyl group. The polyfunctional monomer having a carboxyl group has both a proton donor and an acceptor. For this reason, polymer chains can be pseudo-crosslinked as the mutual interaction therebetween is enhanced in a case in which a polyfunctional monomer having a carboxyl group is contained in the polymer chain as the hydroxyl group-containing polyfunctional ethylenically unsaturated monomer (B1a).

Examples of the hydroxyl group-containing polyfunctional ethylenically unsaturated monomer (B1a) include 2-hydroxy-3-acryloyloxypropyl methacrylate, 1,6-hexanediol diglycidyl ether acrylate, and polyethylene glycol diglycidyl ether acrylate. These may be used singly, or two or more thereof may be used concurrently.

It is preferable that the polyfunctional ethylenically unsaturated monomer having an amino group (hereinafter also referred to as “amino group-containing polyfunctional ethylenically unsaturated monomer (Bib)”) has any partial structure represented by the following general formula (i). In other words, it is preferable that the amino group-containing polyfunctional ethylenically unsaturated monomer (Bib) has an amide bond, a urea bond, or a urethane bond. In the polyfunctional ethylenically unsaturated monomer (Bib) having any partial structure represented by the following general formula (i), two or more polarized moieties are close to each other. For this reason, polymer chains can be pseudo-crosslinked as the mutual interaction therebetween is enhanced in a case in which the amino group-containing polyfunctional ethylenically unsaturated monomer (Bib) having such a structure is contained in the polymer chain.

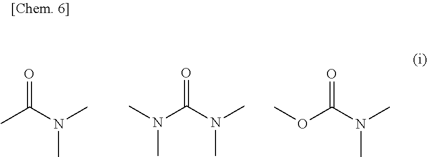

Furthermore, it is more preferable that the amino group-containing polyfunctional ethylenically unsaturated monomer (B1b) has any partial structure represented by the following general formula (ii). In other words, it is more preferable that the polyfunctional ethylenically unsaturated monomer (Bib) has an amide bond in which a hydrogen atom is bonded to a nitrogen atom, a urea bond in which a hydrogen atom is bonded to a nitrogen atom, and a urethane bond in which a hydrogen atom is bonded to a nitrogen atom. The polyfunctional ethylenically unsaturated monomer (B1b) having any partial structure represented by the following general formula (ii) has both a proton donor and an acceptor. For this reason, polymer chains can be pseudo-crosslinked as the mutual interaction therebetween is enhanced in a case in which the amino group-containing polyfunctional ethylenically unsaturated monomer (B1b) having such a structure is contained in the polymer chain.

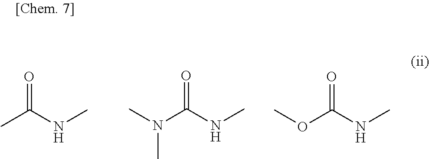

Examples of the amino group-containing polyfunctional ethylenically unsaturated monomer (B1b) include phenyl glycidyl ether acrylate hexamethylene diisocyanate urethane prepolymer (for example, AH-600 manufactured by KYOEISHA CHEMICAL CO., LTD.), urethane acrylate oligomer (for example, CN9002 manufactured by Sartomer), and compounds represented by the following formula (vi). These may be used singly, or two or more thereof may be used concurrently.

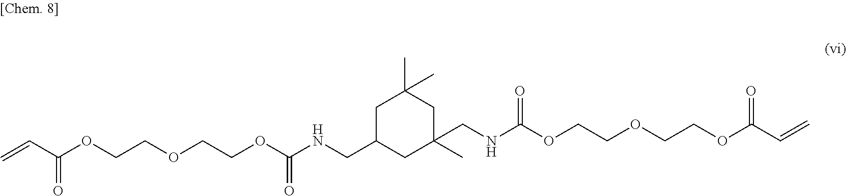 [SMILES: C=CC(=O)OCCOCCOC(=O)NCC1CC(C)(C)CC(C)(CNC(=O)OCCOCCOC(=O)C=C)C1]

It is preferable that the molecular weight of the polyfunctional ethylenically unsaturated monomer (B1) having a hydroxyl group or an amino group is 200 to 1,000 from the viewpoint of adjusting (tending to increase) the viscosity of the composition for model material and thus improving the discharging stability from the inkjet head.

It is preferable that the glass transition temperature of the cured product obtained by photocuring the polyfunctional ethylenically unsaturated monomer (B1) having a hydroxyl group or an amino group is 0° C. or lower from the viewpoint of imparting rubber-like elongation and elasticity to a model material obtained by photocuring the composition for model material.

The polyfunctional ethylenically unsaturated monomer (B) may be a polyfunctional ethylenically unsaturated monomer (B2) which does not have a hydroxyl group and an amino group in a case in which the monofunctional ethylenically unsaturated monomer (A) contained in the composition for model material has a hydroxyl group or an amino group. Moreover, the polyfunctional ethylenically unsaturated monomer (B2) which does not have a hydroxyl group and an amino group may be contained in addition to the polyfunctional ethylenically unsaturated monomer (B1) having a hydroxyl group or an amino group. Examples of the polyfunctional ethylenically unsaturated monomer (B2) include a polyfunctional (meth)acrylate compound and a polyfunctional vinyl ether compound. These may be used singly, or two or more thereof may be used concurrently.

Among the polyfunctional (meth)acrylate compounds, examples of the difunctional (meth)acrylate compound include triethylene glycol di(meth)acrylate, tetraethylene glycol di(meth)acrylate, polyethylene glycol di(meth)acrylate, tripropylene glycol di(meth)acrylate, polypropylene glycol di(meth)acrylate, 1,4-butanediol di(meth)acrylate, 1,6-hexanediol di(meth)acrylate, 1,9-nonanediol di(meth)acrylate, neopentyl glycol di(meth)acrylate, dimethylol-tricyclodecane di(meth)acrylate, PO adduct of bisphenol A di(meth)acrylate, hydroxypivalate neopentyl glycol di(meth)acrylate, and polytetramethylene glycol di(meth)acrylate.

Among the polyfunctional (meth)acrylate compounds, examples of the tri- or higher functional (meth)acrylate compound include trimethylolpropane tri(meth)acrylate, pentaerythritol tri(meth)acrylate, pentaerythritol tetra (meth)acrylate, dipentaerythritol hexa(meth)acrylate, ditrimethylolpropane tetra(meth)acrylate, glycerin propoxy tri(meth)acrylate, and pentaerythritol ethoxy tetra(meth)acrylate.

The polyfunctional (meth)acrylate compound may be a modified product. Examples of the modified product include ethylene oxide-modified (meth)acrylate compounds such as ethylene oxide-modified trimethylolpropane tri(meth)acrylate and ethylene oxide-modified pentaerythritol tetraacrylate; caprolactone-modified (meth)acrylate compounds such as caprolactone-modified trimethylolpropane tri(meth)acrylate; and caprolactam-modified (meth)acrylate compounds such as caprolactam-modified dipentaerythritol hexa(meth)acrylate.

Among the polyfunctional vinyl ether compounds, examples of the difunctional vinyl ether compound include ethylene glycol divinyl ether, diethylene glycol divinyl ether, triethylene glycol divinyl ether, propylene glycol divinyl ether, dipropylene glycol vinyl ether, butylene divinyl ether, dibutylene glycol divinyl ether, neopentyl glycol divinyl ether, cyciohexanediol divinyl ether, cyclohexane dimethanol divinyl ether, norbornyl dimethanol divinyl ether, isobainyl divinyl ether, divinyl resorcin, and divinyl hydroquinone.

Among the polyfunctional vinyl ether compounds, examples of the trifunctional vinyl ether compound include glycerin trivinyl ether, glycerin ethylene oxide adduct trivinyl ether (number of moles of ethylene oxide added: 6), trimethylolpropane trivinyl ether, and trivinyl ether ethylene oxide adduct trivinyl ether (number of moles of ethylene oxide added: 3).

Among the polyfunctional vinyl ether compounds, examples of the tetra- or higher functional vinyl ether compound include pentaerythritol trivinyl ether, ditrimethylolpropane hexavinyl ether, and oxyethylene adducts thereof.

In the composition for model material contained in the optical shaping ink set according to Embodiment (1) of the present invention, at least either of the monofunctional ethylenically unsaturated monomer (A) or the polyfunctional ethylenically unsaturated monomer (B) has a hydroxyl group or an amino group. Preferably, at least either of the monofunctional ethylenically unsaturated monomer (A) or the polyfunctional ethylenically unsaturated monomer (3) has one or more selected from an amide bond, a urea bond, and a urethane bond.

In Embodiment (1) of the present invention, the total molar fraction of the hydroxyl group and amino group in the composition for model material is 5% to 30% with respect to the total amount of the monofunctional ethylenically unsaturated monomer (A) and the polyfunctional ethylenically unsaturated monomer (B). When the total molar fraction of the hydroxyl group and amino group is in the above range, a model material obtained by photocuring the composition for model material and an optically shaped article produced using the model material exhibit rubber-like elongation and elasticity.

In Embodiment (1) of the present invention, the molar fraction of the monofunctional ethylenically unsaturated monomer (A) to the polyfunctional ethylenically unsaturated monomer (B) (monofunctional ethylenically unsaturated monomer (A)/polyfunctional ethylenically unsaturated monomer (B)) in the composition for model material is 92/8 to 99.9/0.1. When the molar fraction of the monofunctional ethylenically unsaturated monomer (A) to the polyfunctional ethylenically unsaturated monomer (B) is in the above range, it is possible to further improve the elongation and elasticity of a model material obtained by photocuring the composition for model material and an optically shaped article produced using the model material.

It is preferable that the composition for model material contained in the optical shaping ink set according to Embodiment (1) of the present invention contains a photopolymerization initiator. The photopolymerization initiator is not particularly limited as long as it is a compound which promotes a radical reaction when being irradiated with light having a wavelength in the ultraviolet light, near ultraviolet light, or visible light region.

Examples of the photopolymerization initiator include benzoin compounds having 14 to 18 carbon atoms (for example, benzoin, benzoin methyl ether, benzoin ethyl ether, benzoin propyl ether, and benzoin isobutyl ether), acetophenone compounds having 8 to 18 carbon atoms [for example, acetophenone, 2,2-diethoxy-2-phenylacetophenone, 2,2-diethoxy-2-phenylacetophenone, 1,1-dichloroacetcphenone, 2-hydroxy-2-methyl-phenylpropan-1-one, diethcxyacetophenone, 1-hydroxycyclohexyl phenyl ketone, and 2-methyl-1-[4-(methylthio)phenyl]-2-morpholinopropan-1-one], anthraquinone compounds having 14 to 19 carbon atoms (for example, 2-ethyl anthraquinone, 2-t-butyl anthraquinone, 2-chlorcanthraquinone, and 2-amyl anthraquinone), thioxanthone compounds having 13 to 17 carbon atoms [for example, 2,4-diethylthioxanthone, 2-isopropylthioxanthone, and 2-chlorothioxanthone], ketal compounds having 16 to 17 carbon atoms (for example, acetophenone dimethyl ketal and benzyl dimethyl ketal), benzophenone compounds having 13 to 21 carbon atoms (for example, benzophenone, 4-benzoyl-4′-methyldiphenyl sulfide, and 4,4′-bismethylaminobenzophenone), acylphosphine oxide compounds having 22 to 28 carbon atoms [for example, 2,4,6-trimethylbenzoyl-diphenyl-phosphine oxide, bis-(2,6-dimethoxybenzoyl)-2,4,4-trimethylpentylphosphine oxides, and bis(2,4,6-trimethylbenzoyl)-phenylphosphine oxide], and any mixture of these compounds. These may be used singly, or two or more thereof may be used concurrently. Among these, an acylphosphine oxide compound is preferable, and 2,4,6-trimethylbenzoyl-diphenyl-phosphine oxide is more preferable from the viewpoint of improving the light resistance of a model material obtained by photocuring the composition for model material. In addition, examples of available acylphosphine oxide compounds include DAROCURE TPO manufactured by BASF.

In Embodiment (1) of the present invention, the content of the photopolymerization initiator in the composition for model material is preferably 0.01 parts by weight or more, preferably 10 parts by weight or less, and more preferably 1.5 parts by weight or less with respect to 100 parts by weight of the total amount of the composition for model material. Incidentally, the content is the total content of photopolymerization initiators in a case in which two or more photopolymerization initiators are contained.

In Embodiment (1) of the present invention, it is preferable that the Tg of a model material obtained by photocuring the composition for model material is lower than 25° C. from the viewpoint of improving elongation and elasticity. The Tg of the model material is more preferably 5° C. or lower, still more preferably 0° C. or lower, and particularly preferably lower than −25° C.

In another embodiment of the present invention, the composition for model material constituting the optical shaping ink set of the present invention comprises an ethylenically unsaturated monomer (C) of which a homopolymer has a glass transition temperature of 25° C. or higher and 120° C. or lower, an ethylenically unsaturated monomer (D) of which a homopolymer has a glass transition temperature of −65° C. or higher and lower than 25° C., a bifunctional acrylate oligomer (E) having a weight average molecular weight of 800 or more and 10,000 or less, and an acylphosphine oxide compound. The content of a bi- or higher functional acrylate compound is 15 parts by weight or less with respect to 100 parts by weight of the total amount of the composition for model material. By use of a composition for model material having the constitution, it is possible to form an optically shaped article (model material) which is soft and excellent in tensile strength.

Hereinafter, an embodiment including the composition for model material (hereinafter, also referred to as “Embodiment (2) of the present invention”) will be described.

<Ethylenically Unsaturated Monomer (C)>

The composition for model material contained in the optical shaping ink set according to Embodiment (2) of the present invention comprises an ethylenically unsaturated monomer (C). The glass transition temperature (hereinafter referred to as Tg) of a homopolymer of the ethylenically unsaturated monomer (C) is 25° C. or higher and 120° C. or lower. When the Tg of the ethylenically unsaturated monomer (C) is in the above range, it is possible to improve the softness and tensile strength of a model material obtained by photocuring the composition for model material and an optically shaped article produced using the model material. Moreover, the model material is hardly broken when removing the support material to be described later and the formability can be thus improved. The Tg of a homopolymer of the ethylenically unsaturated monomer (C) is preferably 30° C. or higher and more preferably 60° C. or higher. Moreover, it is preferable that the Tg of a homopolymer of the ethylenically unsaturated monomer (C) is 100′C or lower. Incidentally, Tg can be measured by using a differential thermal analyzer (TG-DTA (2000S) manufactured by Mac Science). In addition, it is preferable that the molecular weight of the ethylenically unsaturated monomer (C) is 150 to 600.

The ethylenically unsaturated monomer (C) may be an acrylate compound or a methacrylate compound but is preferably an acrylate compound. In addition, the ethylenically unsaturated monomer (C) may be a monofunctional ethylenically unsaturated monomer or a polyfunctional ethylenically unsaturated monomer but is preferably a monofunctional ethylenically unsaturated monomer. Furthermore, it is preferable that the ethylenically unsaturated monomer (C) is an ethylenically unsaturated monomer having a hydrocarbon ring structure.

Examples of the ethylenically unsaturated monomer (C) include isobornyl (meth)acrylate, cyclohexyl (meth)acrylate, t-butyl (meth)acrylate, t-butyl cyclohexyl (meth)acrylate, methyl (meth)acrylate, ethyl (meth)acrylate, propyl (meth)acrylate, phenyl (meth)acrylate, benzyl (meth)acrylate, phenethyl (meth)acrylate, dicyclopentanyl (meth)acrylate, 2-hydroxyethyl (meth)acrylate, 2-methacryloyloxyethyl hexahydrophthalic acid, 3-hydroxypropyl (meth)acrylate, 2-methacryloyloxyethyl phthalic acid, 3,3,5-trimethylcyclohexyl (meth)acrylate, dicyclopentenyl (meth)acrylate, and 1,6-hexanediol di(meth)acrylate. These may be used singly, or two or more thereof may be used concurrently.

Among these, the ethylenically unsaturated monomer (C) is preferably one or more selected from isobornyl acrylate, t-butylcyclohexyl acrylate, 3,3,5-trimethylcyclohexyl acrylate, and dicyclopentanyl acrylate and more preferably isobornyl acrylate and/or t-butylcyclohexyl acrylate. This makes it possible to improve the tensile strength of a model material obtained by photocuring the composition for model material and an optically shaped article produced using the model material. Moreover, the model material is hardly broken when removing the support material to be described later and the formability can be thus improved.

In Embodiment (2) of the present invention, it is preferable that the content of the ethylenically unsaturated monomer (C) in the composition for model material is 1 to 30 parts by weight with respect to 100 parts by weight of the total amount of the composition for model material. When the content of the ethylenically unsaturated monomer (C) is in the above range, it is possible to improve the softness and tensile strength of a model material and an optically shaped article to be obtained. Moreover, the model material is hardly broken when removing the support material to be described later and the formability can be thus improved. The content of the ethylenically unsaturated monomer (C) is more preferably 3 parts by weight or more, still more preferably 5 parts by weight or more, and particularly preferably 10 parts by weight or more. In addition, the content of the ethylenically unsaturated monomer (C) is more preferably 25 parts by weight or less and still more preferably 20 parts by weight or less. Incidentally, the content is the total content of ethylenically unsaturated monomers (C) in a case in which two or more ethylenically unsaturated monomers (C) are contained.

<Ethylenically Unsaturated Monomer (D)>

The composition for model material contained in the optical shaping ink set according to Embodiment (2) of the present invention comprises an ethylenically unsaturated monomer (D). The Tg of a homopolymer of the ethylenically unsaturated monomer (D) is −65° C. or higher and lower than 25° C. When the Tg of the ethylenically unsaturated monomer (D) is in the above range, it is possible to improve the softness and tensile strength of a model material obtained by photocuring the composition for model material and an optically shaped article produced using the model material. Moreover, the model material is hardly broken when removing the support material to be described later and the formability can be thus improved. The Tg of a homopolymer of the ethylenically unsaturated monomer (D) is preferably −30° C. or higher and more preferably −10° C. or higher. Moreover, it is preferable that the Tg of a homopolymer of the ethylenically unsaturated monomer (D) is 10° C. or lower. Incidentally, Tg can be measured by using a differential thermal analyzer (TG-DTA (2000S) manufactured by Xray Science Corporation). In addition, it is preferable that the molecular weight of the ethylenically unsaturated monomer (D) is 150 to 600.

The ethylenically unsaturated monomer (D) may be an acrylate compound or a methacrylate compound but is preferably an acrylate compound. In addition, the ethylenically unsaturated monomer (D) may be a monofunctional ethylenically unsaturated monomer or a polyfunctional ethylenically unsaturated monomer but is preferably a monofunctional ethylenically unsaturated monomer. Furthermore, it is preferable that the ethylenically unsaturated monomer (D) is an ethylenically unsaturated monomer having an ether bond and/or an alkyl group having 8 or more carbon atoms.

Examples of the ethylenically unsaturated monomer (D) include long-chain alkyl (having 8 or more carbon atoms) acrylate compounds, acrylate compounds having a polyethylene oxide or polypropylene oxide chain, phenoxyethyl acrylate compounds, tetrahydrofurfuryl acrylate, and 2-(N-butylcarbamoyloxy)ethyl acrylate (1,2-ethanediol 1-acrylate 2-(N-butylcarbamate)). These may be used singly, or two or more thereof may be used concurrently.

Examples of the long-chain alkyl acrylate compounds include 2-ethylhexyl acrylate, n-octyl acrylate, n-isononyl acrylate, n-decyl acrylate, isooctyl acrylate, n-lauryl acrylate, n-tridecyl acrylate, n-cetyl acrylate, n-stearyl acrylate, isomyristyl acrylate, and isostearyl acrylate.

Examples of the acrylate compounds having a polyethylene oxide or polypropylene oxide chain include (poly)ethylene glycol monoacrylate, (poly)ethylene glycol acrylate methyl ester, (poly)ethylene glycol acrylate ethyl ester, (poly)ethylene glycol acrylate phenyl ester, (poly)propylene glycol monoacrylate, (poly)propylene glycol monoacrylate phenyl ester, (poly)propylene glycol acrylate methyl ester, (poly)propylene glycol acrylate ethyl ester, methoxy triethylene glycol acrylate, methoxy dipropylene glycol acrylate, ethoxy diethylene glycol acrylate (ethoxyethoxyethyl acrylate), and methoxy polyethylene glycol acrylate.

Examples of the phenoxyethyl acrylate compounds include phenoxyethyl acrylate, phenoxydiethylene glycol acrylate, phenoxy polyethylene glycol acrylate, 2-hydroxy-3-phenoxy propyl acrylate, and nonyl phenol ethylene oxide adduct acrylate.

Among these, the ethylenically unsaturated monomer (D) is preferably one or more selected from phenoxyethyl acrylate, n-stearyl acrylate, isodecyl acrylate, ethoxyethoxyethyl acrylate, tetrahydrofurfuryl acrylate, n-lauryl acrylate, n-octyl acrylate, n-decyl acrylate, isooctyl acrylate, n-tridecyl acrylate, and 2-(N-butylcarbamoyloxy)ethyl acrylate, and more preferably phenoxyethyl acrylate and/or n-stearyl acrylate. This makes it possible to improve the tensile strength of a model material obtained by photocuring the composition for model material and an optically shaped article produced using the model material. Moreover, the model material is hardly broken when removing the support material to be described later and the formability can be thus improved.

In Embodiment (2) of the present invention, it is preferable that the content of the ethylenically unsaturated monomer (D) in the composition for model material is 10 to 90 parts by weight with respect to 100 parts by weight of the total amount of the composition for model material. When the content of the ethylenically unsaturated monomer (D) is in the above range, it is possible to improve the softness and tensile strength of a model material obtained by photocuring the composition for model material and an optically shaped article produced using the model material. Moreover, the model material is hardly broken when removing the support material to be described later and the formability can be thus improved. The content of the ethylenically unsaturated monomer (D) is more preferably 30 parts by weight or more, still more preferably 40 parts by weight or more, and particularly preferably 50 parts by weight or more. In addition, the content of the ethylenically unsaturated monomer (D) is more preferably 85 parts by weight or less, still more preferably 80 parts by weight or less, and particularly preferably 75 parts by weight or less. Incidentally, the content is the total content of ethylenically unsaturated monomers (D) in a case in which two or more ethylenically unsaturated monomers (D) are contained.

In addition, the content M(C) of the ethylenically unsaturated monomer (C) and the content M(D) of the ethylenically unsaturated monomer (D) satisfy preferably M(C)<M(D) (M(C) is smaller than M(D)), more preferably 2×M(C)<M(D) (a value obtained by multiplying M(C) by 2 is smaller than M(D)), and still more preferably 3×M(C)<M(D) (a value obtained by multiplying M(C) by 3 is smaller than M(D)). This makes it possible to improve the tensile strength of a model material obtained by photocuring the composition for model material and an optically shaped article produced using the model material. Moreover, the model material is hardly broken when removing the support material to be described later and the formability can be thus improved.

In addition, the content M(C) of the ethylenically unsaturated monomer (C) and the content M (D) of the ethylenically unsaturated monomer (D) satisfy preferably 10×M(C)>M(D) (a value obtained by multiplying M(C) by 10 is greater than M(D)), more preferably 7×M(C)>M(D) (a value obtained by multiplying M(C) by 7 is greater than M(D)), and still more preferably 5×M(C)>M(D) (a value obtained by multiplying M(C) by 5 is greater than M(D)).

<Bifunctional Acrylate Oligomer (E)>

The composition for model material contained in the optical shaping ink set according to Embodiment (2) of the present invention comprises a bifunctional acrylate oligomer (E). The bifunctional acrylate oligomer (E) has a weight average molecular weight (hereinafter referred to as Mw) of 800 or more and 10,000 or less. When the Mw of the bifunctional acrylate oligomer (E) is in the above range, it is possible to improve the softness and tensile strength of a model material obtained by photocuring the composition for model material and an optically shaped article produced using the model material. It is preferable that the Mw of the bifunctional acrylate oligomer (E) is 10,000 or less and 5,000 or less.

Incidentally, Mw can be measured by gel permeation chromatography (GPC) analysis. In more detail, Mw can be measured under the conditions of solvent: tetrahydrofuran (10 mM LiBr), flow rate: 0.5 mL/min, sample concentration: 0.1% by mass, injection volume: 60 μL, and measurement temperature: 40° C. using HLC-8220 GPC manufactured by Tosoh Corporation and three TSK gel Super AWM-H connected to one another as a column. As the detector, a UV or RI detector (differential refractometer) can be used.

The bifunctional acrylate oligomer (E) may have an acryloyloxy group or a methacryloyloxy group but preferably has an acryloyloxy group. In addition, the bifunctional acrylate oligomer (E) is an oligomer having two acryloyloxy groups and/or methacryloyloxy groups in total. When the composition for model material contains only monofunctional acrylate oligomers, a model material and an optically shaped article to be obtained tend to be inferior in tensile strength. On the other hand, when the composition for model material contains only tri- or higher functional acrylate oligomers, a model material and an optically shaped article to be obtained tend to be inferior in softness.

It is preferable that the Young's modulus of the bifunctional acrylate oligomer (E) at 25° C. is 1 to 100 MPa. When the Young's modulus of the bifunctional acrylate oligomer (E) is in the above range, it is possible to improve the softness and tensile strength of a model material and an optically shaped article to be obtained. The Young's modulus of the bifunctional acrylate oligomer (E) is more preferably 2 MPa or more, still more preferably 3 MPa or more, and particularly preferably 10 MPa or more. On the other hand, the Young's modulus of the bifunctional acrylate oligomer (E) is more preferably 80 MPa or less, still more preferably 50 MPa or less, and particularly preferably 30 MPa or less.

Here, the Young's modulus of the bifunctional acrylate oligomer (E) at 25° C. is the Young's modulus of a homopolymer (monopolymer) of the bifunctional acrylate oligomer (E) at 25° C. The method for measuring the Young's modulus can be performed by the following method, for example. A liquid in which 2% by mass of Irgacure 819 (manufactured by BASFE), 2% by mass of Irgacure 184 (manufactured by BASF), and 96% by mass of the oligomer to be measured are mixed together is formed into a coating film of 100 μm using a bar coater and cured using ultraviolet (UV) exposing equipment. At this time, curing is performed to such an extent that the influence of the degree of polymerization of the cured film is negligible. This cured film is cut into a strip shape of 15 mm×50 mm, and the Young's modulus is measured using a tensile tester (Autograph AGS-X 5KN manufactured by Shimadzu Corporation). In addition, the value of Young's modulus is measured at the portion having elongation of 1%. In addition, in the test, the cured film is pulled in the longitudinal direction and a portion of about 10 mm up and down is gripped with a clamp.

Examples of the bifunctional acrylate oligomer (E) include olefin-based oligomers (ethylene oligomer, propylene oligomer, butene oligomer and the like), vinyl-based oligomers (styrene oligomer, vinyl alcohol oligomer, vinyl pyrrolidone oligomer, acrylic resin oligomer and the like), diene-based oligomers (butadiene oligomer, chloroprene rubber, pentadiene oligomer and the like), ring-opening polymerization-based oligomers (di-, tri-, and tetraethylene glycols, polyethylene glycol, polyethylimine and the like), polyaddition-based oligomers (oligoester acrylate, polyamide oligomer, polyisocyanate oligomer and the like), and addition condensation oligomers (phenol resin, amino resin, xylene resin, ketone resin and the like). Among these, urethane acrylate oligomer, polyester acrylate oligomer, or epoxy acrylate oligomer is preferable and urethane acrylate oligomer is more preferable. As the urethane acrylate oligomer, the polyester acrylate oligomer can be used, and as the epoxy acrylate oligomer, reference can be made to an oligomer handbook (supervised by FURUKAWA Junji, The Chemical Daily Co., Ltd.). Moreover, as the bifunctional acrylate oligomer (E), those marketed by Shin-Nakamura Chemical Co., Ltd., Sartomer, DAICEL-CYTEC COMPANY LTD., Rahn AG and the like can be used.

In Embodiment (2) of the present invention, it is preferable that the content of the bifunctional acrylate oligomer (E) is 1 to 15 parts by weight with respect to 100 parts by weight of the total amount of the composition for model material. When the content of the bifunctional acrylate oligomer (E) is in the above range, it is possible to improve the softness and tensile strength of a model material and an optically shaped article to be obtained. The content of the bifunctional acrylate oligomer (E) is more preferably 3 parts by weight or more and still more preferably 5 parts by weight or more. Incidentally, the content is the total content of bifunctional acrylate oligomers (E) in a case in which two or more bifunctional acrylate oligomers (E) are contained.

The content of di- or higher functional acrylate compounds in the components (C), (D), and (E) is 15 parts by weight or less with respect to 100 parts by weight of the total amount of the composition for model material.

In addition, the content of the bifunctional acrylate oligomer (E) is preferably 50 parts by weight or more with respect to 100 parts by weight of the total amount of the di- or higher functional acrylate compounds. When the content of the bifunctional acrylate oligomer (E) is in the above range, it is possible to improve the softness and tensile strength of a model material obtained by photocuring the composition for model material and an optically shaped article produced using the model material. The content of the bifunctional acrylate oligomer (E) is more preferably 80 parts by weight or more, still more preferably 90 parts by weight or more, and particularly preferably 95 parts by weight or more with respect to 100 parts by weight of the total amount of the di- or higher functional acrylate compounds.

<Acylphosphine Oxide Compound>

The composition for model material contained in the optical shaping ink set according to Embodiment (2) of the present invention comprises an acylphosphine oxide compound as a photopolymerization initiator. As the composition for model material contains an acylphosphine oxide compound, it is possible to improve the softness and tensile strength of a model material and an optically shaped article to be obtained. In addition, by use of an acylphosphine oxide compound as the photopolymerization initiator, it is possible to diminish the coloration of model material and optically shaped article derived from the residues or decomposition products of the photopolymerization initiator.

Examples of the acylphosphine oxide compound include bis(2,4,6-trimethyl benzoyl)phenylphosphine oxide and bis(2,6-dimethyl benzoyl)phenylphosphine oxide. These may be used singly, or two or more thereof may be used concurrently.

In Embodiment (2) of the present invention, it is preferable that the content of the acylphosphine oxide compound is 1 to 20 parts by weight with respect to 100 parts by weight of the total amount of the composition for model material. When the content of the acylphosphine oxide compound is in the above range, it is possible to improve the softness and tensile strength of a model material and an optically shaped article to be obtained. The content of the acylphosphine oxide compound is more preferably 2 parts by weight or more and still more preferably 5 parts by weight or more. In addition, the content of the acylphosphine oxide compound is more preferably 15 parts by weight or less. Incidentally, the content is the total content of acylphosphine oxide compounds in a case in which two or more acylphosphine oxide compounds are contained.

Moreover, in Embodiment (2) of the present invention, the composition for model material may comprise a photcpolymerization initiator other than an acylphosphine oxide compound. Examples of the photopolymerization initiator other than an acylphosphine oxide compound include the same ones as those exemplified above as a photopolymerization initiator which can be contained in the composition for model material in Embodiment (1) of the present invention.

<Other Additives>

The compositions for model material contained in the ink sets for stereolithography according to Embodiments (1) and (2) of the present invention described above can respectively comprise the other additives if necessary in the range in which the effect of the present invention is not inhibited. Examples of the other additives include a sensitizer, a coloring agent, a dispersant, a surfactant, a polymerization inhibitor, a storage stabilizer, a co-sensitizer, an ultraviolet absorber, an antioxidant, an antifading agent, a conductive salt, a solvent, a high molecular compound, a basic compound, a leveling additive, a matting agent, a polyester-based resin, a polyurethane-based resin, a vinyl-based resin, an acrylic resin, and a rubber-based resin for adjusting physical properties of film, waxes, an auxiliary polymerization inhibitor, and a release accelerator.

Examples of the sensitizer include polynuclear aromatics (for example, pyrene, perylene, triphenylene, and 2-ethyl-9, 10-dimethoxyanthracene), thioxanthones (for example, isopropyl thioxanthone), and thiochromanones (for example, thiochromanone). These may be used singly, or two or more thereof may be used concurrently. Among these, thioxanthones are preferable and isopropyl thioxanthone is more preferable.

The content of the sensitizer is preferably 0.1 to 5 parts by weight with respect to 100 parts by weight of the total amount of the composition for model material. When the content of the sensitizer is in the above range, the model material to be obtained is excellent in curability and curing sensitivity. The content of the sensitizer is more preferably 0.5 parts by weight or more and more preferably 3 parts by weight or less. Incidentally, the content is the sum of contents of the respective sensitizers in a case in which two or more sensitizers are contained.

As the coloring agent, various publicly-known pigments and dyes can be appropriately selected and used depending on the application, but a pigment is preferable from the viewpoint of excellent light resistance. The pigment is not particularly limited, and all commercially available organic pigments, inorganic pigments, pigments obtained by dyeing resin particles with a dye, and the like can be used. Moreover, commercially available pigment dispersions, surface-treated pigments, for example, those in which a pigment is dispersed in an insoluble resin and the like as a dispersion medium and those in which a resin is grafted on the pigment surface, and the like can also be used as long as the effect of the present invention is not impaired.

Examples of organic pigments and inorganic pigments exhibiting yellow color include monoazo pigments such as C.I. Pigment Yellow 1 (Fast Yellow G and the like) and C.I. Pigment Yellow 74; disazo pigments such as C.I. Pigment Yellow 12 (Disazo Yellow AAA and the like) and C.I. Pigment Yellow 17; non-benzidine azo pigments such as C.I. Pigment Yellow 180; azo lake pigments such as C.I. Pigment Yellow 100 (Tartrazine Yellow Lake and the like); condensed azo pigments such as C.I. Pigment Yellow 95 (Condensed Azo Yellow GR and the like); acid dye lake pigments such as C.I. Pigment Yellow 115 (Quinoline Yellow Lake and the like); basic dye lake pigments such as C.I. Pigment Yellow 18 (Thioflavin Lake and the like); anthraquinone pigments such as Flavantron Yellow (Y-24); isoindolinone pigments such as Isoindolinone Yellow 3RLT (Y-110); quinophthalone pigments such as Quinophthalone Yellow (Y-138); isoindoline pigments such as Isoindoline Yellow (Y-139); nitroso pigments such as C.I. Pigment Yellow 153 (Nickel Nitroso Yellow and the like); and metal complex salt azomethine pigments such as C.I. Pigment Yellow 117 (Copper Azomethine Yellow and the like). These may be used singly, or two or more thereof may be used concurrently.

Examples of organic pigments and inorganic pigments exhibiting red or magenta color include monoazo pigments such as C.I. Pigment Red 3 (Toluidine Red and the like); disazo pigments such as C.I. Pigment Red 38 (Pyrazolone Red B and the like); azo lake pigments such as C.I. Pigment Red 53:1 (Lake Red C, and the like) and C.I. Pigment Red 57:1 (Brilliant Carmine 6B); condensed azo pigments such as C.I. Pigment Red 144 (Condensed Azo Red BR and the like); acid dye lake pigments such as C.I. Pigment Red 174 (Floxin B Lake and the like); basic dye lake pigments such as C.I. Pigment Red 81 (Rhodamine 6G′ Lake and the like), anthraquinone pigments such as C.I. Pigment Red 177 (Dianthraquinonyl Red and the like), thioindigo pigments such as C.I. Pigment Red 88 (Thioindigo Bordeaux and the like); perinone pigments such as C.I. Pigment Red 194 (Perinone Red and the like); perylene pigments such as C.I. Pigment Red 149 (Perylene Scarlet and the like); quinacridone pigments such as C.I. Pigment Violet 19 (unsubstituted quinacridone) and C.I. Pigment Red 122 (Quinacridone Magenta and the like); isoindolinone pigments such as C.I. Pigment Red 180 (Isoindolinone Red 2BLT and the like); and alizarin lake pigments such as C.I. Pigment Red 83 (Madder Lake and the like). These may be used singly, or two or more thereof may be used concurrently.

Examples of organic pigments and inorganic pigments exhibiting blue or cyan color include disazo pigments such as C.I. Pigment Blue 25 (Dianisidine Blue and the like); phthalocyanine pigments such as C.I. Pigment Blue 15 (such as Phthalocyanine Blue); acid dye lake pigments such as C.I. Pigment Blue 24 (Peacock Blue Lake and the like); basic dye lake pigments such as C.I. Pigment Blue 1 (Biclothia Pure Blue BO Lake and the like); anthraquinone pigments such as C.I. Pigment Blue 60 (Indanthrone Blue and the like); and alkali blue pigments such as C.I. Pigment Blue 18 (Alkali Blue V-5:1). These may be used singly, or two or more thereof may be used concurrently.

Examples of organic pigments and inorganic pigments exhibiting green color include phthalocyanine pigments such as C.I. Pigment Green 7 (Phthalocyanine Green) and C.I. Pigment Green 36 (Phthalocyanine Green); and azo metal complex pigments such as C.I. Pigment Green 8 (Nitroso Green). These may be used singly, or two or more thereof may be used concurrently.

Examples of organic pigments and inorganic pigments exhibiting orange color include isoindoline-based pigments such as C.I. Pigment Orange 66 (Isoindoline Orange); and anthraquinone pigments such as C.I. Pigment Orange 51 (Dichloropyranthrone Orange). These may be used singly, or two or more thereof may be used concurrently.

Examples of organic pigments and inorganic pigments exhibiting black color include Carbon Black, Titanium Black, and Aniline Black. These may be used singly, or two or more thereof may be used concurrently.

Examples of organic pigments and inorganic pigments exhibiting white color include basic lead carbonate (2PbCO₃Pb(OH)₂, so-called, Silver White), zinc oxide (ZnO, so-called Zinc White), titanium oxide (TiO₂, sc-called Titanium White), and strontium titanate (SrTiO₃, so-called Titanium Strontium White). These may be used singly, or two or more thereof may be used concurrently. Among these, titanium oxide is preferable from the viewpoint of having great hiding power and coloring power as a pigment and further exhibiting excellent durability to acids, alkalis, and other environments.

The content of the coloring agent is preferably 0.01 to 40 parts by weight with respect to 100 parts by weight of the total amount of the composition for model material from the viewpoint of colorability and storage stability. The content of the coloring agent is more preferably 0.1 parts by weight or more and still more preferably 0.2 parts by weight or more. In addition, the content of the coloring agent is more preferably 30 parts by weight or less and still more preferably 20 parts by weight or less. Incidentally, the content is the sum of contents of the respective coloring agents in a case in which two or more coloring agents are contained.

In the present invention, it is preferable that the dispersant is a polymer dispersant having an Mw of 1,000 or more. Examples of the polymer dispersant include DISPERBYK-101, DISPERBYK-102 and the like (manufactured by BYK); EFKA 4010, EFKA 4046 and the like (all manufactured by Efka Additives); Disperse-Ayd 6, Disperse-Ayd 8 and the like (all manufactured by SAN NOPCO LIMITED); various kinds of SOLSPERSE dispersants such as SOLSPERSE 3000, 5000 and the like (all manufactured by Noveon, Lubrizol Corporation); ADEKA PLURONIC L31, F38 and the like (all manufactured by ADEKA Corporation); IONET S-20 (manufactured by Sanyo Chemical Industries, Ltd.); and DISPARLON KS-860, 873SN and the like (all manufactured by Kusumoto Chemicals, Ltd.). These may be used singly, or two or more thereof may be used concurrently.

It is preferable that the content of the dispersant is 0.05 to 15 parts by weight with respect to 100 parts by weight of the total amount of the composition for model material. Incidentally, the content is the sum of contents of the respective dispersants in a case in which two or more dispersants are contained.

Examples of the surfactant include anionic surfactants such as dialkyl sulfosuccinates, alkyl naphthalene sulfonates, and fatty acid salts; nonionic surfactants such as polyoxyethylene alkyl ethers, polyoxyethylene alkyl allyl ethers, acetylene glycols, and polyoxyethylene/polyoxypropylene block copolymers; cationic surfactants such as alkylamine salts and quaternary ammonium salts; fluorine-based surfactants such as organic fluoro compounds; and silicone-based surfactants such as polysiloxane compounds. These may be used singly, or two or more thereof may be used concurrently. Among these, silicone-based surfactants are preferable and a polysiloxane compound is more preferable. The surfactant also functions as a peeling accelerator which facilitates peeling off of the model material from the support material obtained by photocuring the composition for support material to be described later. The surfactant may be added in either of the composition for model material or the composition for support material but is preferably contained in both of these.

It is preferable that the content of the surfactant is 0.0001 to 3 parts by weight with respect to 100 parts by weight of the total amount of the composition for model material. Incidentally, the content is the sum of contents of the respective surfactants in a case in which two or more surfactants are contained. In addition, in a case in which a surfactant is used as a peeling accelerator, the content thereof is preferably 0.01 to 3.0 parts by weight with respect to 100 parts by weight of the total amount of the composition for model material. When the amount of the surfactant is in the above range, the peeling property can be improved while suppressing bleeding which is caused by coalescence of the droplets of the composition for model material.

The polymerization inhibitor enhances the storage property of the composition for model material and improves the discharging stability from the inkjet head. Examples of the polymerization inhibitor include nitroso-based polymerization inhibitors, hydroquinone, methoxyhydroquinone, benzoquinone, p-methoxyphenol, TEMPO, TEMPOL (HO-TEMPO), cupferron A1, and hindered amines.

It is preferable that the content of the polymerization inhibitor is 0.001 to 1.5 parts by weight with respect to 100 parts by weight of the total amount of the composition for model material. When the content of the polymerization inhibitor is in the above range, the storage property of the composition for model material is further improved and the discharging stability from the inkjet head is further improved. The content of the polymerization inhibitor is more preferably 0.01 parts by weight or more and still more preferably 0.05 parts by weight or more. In addition, the content of the polymerization inhibitor is more preferably 1.0 part by weight or less and still more preferably 0.8 parts by weight or less. Incidentally, the content is the sum of contents of the respective polymerization inhibitors in a case in which two or more polymerization inhibitors are contained.

The auxiliary polymerization inhibitor is preferably a tertiary amine compound and more preferably an aromatic tertiary amine compound. Examples of the aromatic tertiary amine compound include N,N-dimethylaniline and N,N-diethylaniline. Among these, N,N-dimethylamino-p-benzoic acid ethyl ester and N,N-dimethylamino-p-benzoic acid isoamyl ethyl ester are preferable. These may be used singly, or two or more thereof may be used concurrently.

The method for producing the composition for model material contained in the optical shaping ink set according to the present embodiment is not particularly limited. For example, the composition for model material can be produced by uniformly mixing the respective components constituting the composition for model material using a mixing and stirring apparatus and the like.

It is preferable that the composition for model material produced in this manner has a viscosity of 70 mPa·s or less at 25° C. from the viewpoint of improving the dischargeability from the inkjet head. Incidentally, the measurement of the viscosity of the composition for model material is performed using R100 type viscometer in accordance with JIS Z 8803.

2. Composition for support material

<Water-Soluble Monofunctional Ethylenically Unsaturated Monomer (a)>

The composition for support material contained in the optical shaping ink set according to the present embodiment contains a water-soluble monofunctional ethylenically unsaturated monomer (a). The water-soluble monofunctional ethylenically unsaturated monomer (a) is a component which is polymerized by being irradiated with light to cure the composition for support material. Moreover, the water-soluble monofunctional ethylenically unsaturated monomer (a) is a component which quickly dissolves the support material obtained by photocuring the composition for support materials in water.

The water-soluble monofunctional ethylenically unsaturated monomer (a) is a water-soluble polymerizable monomer having one ethylenic double bond in the molecule and exhibiting the property of being cured by energy rays. Examples of the component (a) include hydroxyl group-containing (meth)acrylates having 5 to 15 carbon atoms [for example, hydroxyethyl (meth)acrylate, hydroxypropyl (meth)acrylate, 4-hydroxybutyl (meth)acrylate and the like], alkylene oxide adduct-containing (meth)acrylates having an Mn of 200 to 1,000 [for example, polyethylene glycol mono(meth)acrylate, monoalkoxy (1 to 4 carbon atoms) polyethylene glycol mono(meth)acrylate, polypropylene glycol mono(meth)acrylate, monoalkoxy (1 to 4 carbon atoms) polypropylene glycol mono(meth)acrylate, and mono(meth)acrylate of PEA-PPA block polymer], (meth)acrylamide derivatives having 3 to 15 carbon atoms [for example, (meth)acrylamide, N-methyl (meth)acrylamide, N-ethyl (meth)acrylamide, N-propyl (meth)acrylamide, N-butyl (meth)acrylamide, N,N′-dimethyl (meth)acrylamide, N,N′-diethyl (meth)acrylamide, N-hydroxyethyl (meth)acrylamide, N-hydroxypropyl (meth)acrylamide, and N-hydroxybutyl (meth)acrylamide], and (meth)acryloyl morpholine. These may be used singly, or two or more thereof may be used concurrently.

Among these, the water-soluble monofunctional ethylenically unsaturated monomer (a) is preferably N,N′-dimethyl (meth)acrylamide, N-hydroxyethyl (meth)acrylamide, (meth)acryloyl morpholine or the like from the viewpoint of improving the curability of the composition for support material. Furthermore, N-hydroxyethyl (meth)acrylamide and (meth)acryloyl morpholine are more preferable from the viewpoint of low skin irritation to the human body.

The content of the water-soluble monofunctional ethylenically unsaturated monomer (a) is 20 to 50 parts by weight with respect to 100 parts by weight of the total amount of the composition for support material. When the content of the water-soluble monofunctional ethylenically unsaturated monomer (a) is less than 20 parts by weight, the self-standing ability of the support material to be obtained is not sufficient. For this reason, the model material cannot be sufficiently supported when the support material is disposed in the lower layer of the model material. As a result, the dimensional accuracy of the model material to be obtained deteriorates. On the other hand, when the content of the water-soluble monofunctional ethylenically unsaturated monomer (a) exceeds 50 parts by weight, the support material to be obtained is inferior in the solubility in water. When the immersion time in water until the support material is completely removed is long, the model material slightly expands. As a result, the dimensional accuracy may deteriorate at the microstructure portion of the model material to be obtained. The content of the water-soluble monofunctional ethylenically unsaturated monomer (a) is preferably 25 parts by weight or more and preferably 45 parts by weight or less. Incidentally, the content is the sum of contents of the respective components (a) in a case in which two or more water-soluble monofunctional ethylenically unsaturated monomers (a) are contained.

<Polyalkylene Glycol (b) Containing Oxyethylene Group and/or Oxypropylene Group>

The composition for support material contained in the optical shaping ink set according to the present embodiment comprises a polyalkylene glycol (b) containing an oxyethylene group and/or an oxypropylene group. By containing the polyalkylene glycol (b), it is possible to improve the solubility of the support material to be obtained in water.

The polyalkylene glycol (b) is obtained by adding at least ethylene oxide and/or propylene oxide to an active hydrogen compound. Examples of the polyalkylene glycol (b) include polyethylene glycol and polypropylene glycol. These may be used singly, or two or more thereof may be used concurrently. Examples of the active hydrogen compound include monohydric to tetrahydric alcohols and amine compounds. Among these, a dihydric alcohol or water is preferable.

The number average molecular weight Mn of the polyalkylene glycol (b) is preferably 100 to 5,000. When the Mn of the polyalkylene glycol (b) is in the above range, the polyalkylene glycol (b) is compatible with the water-soluble monofunctional ethylenically unsaturated monomer (a) before photocuring and is incompatible with the water-soluble monofunctional ethylenically unsaturated monomer (a) after photocuring. As a result, the self-standing ability of the support material to be obtained can be improved and the solubility of the support material in water can be improved. The Mn of the polyalkylene glycol (b) is more preferably 200 to 3,000 and still more preferably 400 to 2,000.

The content of the polyalkylene glycol (b) is 20 to 49 parts by weight with respect to 100 parts by weight of the total amount of the composition for support material. When the content of the polyalkylene glycol (b) is less than 20 parts by weight, the support material to be obtained is inferior in the solubility in water. When the immersion time in water until the support material is completely removed is long, the model material slightly expands. As a result, the dimensional accuracy may deteriorate at the microstructure portion of the model material to be obtained. On the other hand, when the content of the polyalkylene glycol (b) exceeds 49 parts by weight, exudation of the polyalkylene glycol (b) may occur when the composition for support material is photocured. When the exudation of the polyalkylene glycol (b) occurs, the adhesive property at the interface between the support material and the model material deteriorates. As a result, the model material may be easily peeled off from the support material when being cured and shrunk and the dimensional accuracy of the model material to be obtained may deteriorate. In addition, when the content of the polyalkylene glycol (b) exceeds 49 parts by weight, the viscosity of the composition for support material tends to increase. For this reason, the jetting property may deteriorate and flight bending may be caused when the composition for support material is discharged from the inkjet head. As a result, the dimensional accuracy of the support material to be obtained deteriorates and thus the dimensional accuracy of the model material formed on the upper layer of the support material is also likely to deteriorate. The content of the polyalkylene glycol (b) is preferably 25 parts by weight or more and preferably 45 parts by weight or less. Incidentally, the content is the sum of contents of the respective components (b) in a case in which two or more polyalkylene glycols (b) are contained.

<Water-Soluble Organic Solvent (c)>

The composition for support material contained in the optical shaping ink set according to the present embodiment comprises a water-soluble organic solvent (c). The water-soluble organic solvent (c) is a component which improves the solubility of the support material in water. Moreover, the water-soluble organic solvent (c) is a component which adjusts the viscosity of the composition for support materials to a lower value.

Examples of the water-soluble organic solvent (c) include ethylene glycol monoacetate, propylene glycol monoacetate, tripropylene glycol monoacetate, tetraethylene glycol monoacetate, ethylene glycol monomethyl ether, propylene glycol monomethyl ether, ethylene glycol monoethyl ether, propylene glycol monoethyl ether, triethylene glycol monomethyl ether, ethylene glycol monopropyl ether, propylene glycol monopropyl ether, ethylene glycol monobutyl ether, propylene glycol monobutyl ether, ethylene glycol diacetate, propylene glycol diacetate, ethylene glycol dimethyl ether, propylene glycol dimethyl ether, ethylene glycol diethyl ether, propylene glycol diethyl ether, ethylene glycol dipropyl ether, propylene glycol dipropyl ether, ethylene glycol dibutyl ether, propylene glycol dibutyl ether, ethylene glycol monomethyl ether acetate, propylene glycol monomethyl ether acetate, ethylene glycol monoethyl ether acetate, propylene glycol monoethyl ether acetate, ethylene glycol monopropyl ether acetate, propylene glycol monopropyl ether acetate, ethylene glycol monobutyl ether acetate, and propylene glycol monobutyl ether acetate. These may be used singly, or two or more thereof may be used concurrently. Among these, triethylene glycol monomethyl ether or dipropylene glycol monomethyl ether acetate is more preferable from the viewpoint of improving the solubility of the support material in water and adjusting the viscosity of the composition for support material to a lower value.

The content of the water-soluble organic solvent (c) is 35 parts by weight or less with respect to 100 parts by weight of the total amount of the composition for support material. When the content of the water-soluble organic solvent (c) exceeds 35 parts by weight, exudation of the water-soluble organic solvent (c) is likely to occur when the composition for support material is photocured. For this reason, the dimensional accuracy of the model material formed on the upper layer of the support material is likely to deteriorate. The content of the water-soluble organic solvent (c) is preferably 5 parts by weight or more and more preferably 10 parts by weight or more from the viewpoint of improving the solubility of the support material to be obtained in water and adjusting the viscosity of the composition for support materials to a lower value. Moreover, the content of the water-soluble organic solvent (c) is preferably 30 parts by weight or less. Incidentally, the content is the sum of contents of the respective components (c) in a case in which two or more water-soluble organic solvents (c) are contained.

<Photopolymerization Initiator>

The composition for support material contained in the optical shaping ink set according to the present embodiment comprises a photopolymerization initiator (d). The photopolymerization initiator (d) is not particularly limited as long as it is a compound which promotes a radical reaction by being irradiated with light having a wavelength in the ultraviolet light, near ultraviolet light, or visible light region, and it is possible to use components which are the same as those previously exemplified as a photopolymerization initiator which can be contained in the composition for model material of Embodiment (1) of the present invention.

The content of the photopolymerization initiator (d) is preferably 1 to 25 parts by weight and more preferably 2 to 20 parts by weight with respect to 100 parts by weight of the total amount of the composition for support material. When the content of the photopolymerization initiator (d) is in the above range, the self-standing ability of the composition for support material is improved. For this reason, the dimensional accuracy of the model material formed on the upper layer of the support material formed from this composition for support material is improved. The content of the photopolymerization initiator (d) is more preferably 3 parts by weight or more, still more preferably 5 parts by weight or more, particularly preferably 7 parts by weight or more, and more preferably 18 parts by weight or less. Incidentally, the content is the sum of contents of the respective components (d) in a case in which two or more components (d) are contained.

<Surface Conditioner (e)>

It is preferable that the composition for support material contained in the optical shaping ink set according to the present embodiment comprises a surface conditioner (e) in order to adjust the surface tension of the composition to a proper range. By adjusting the surface tension of the composition to a proper range, it is possible to suppress mixing of the composition for model material with the composition for support material at the interface. As a result, it is possible to obtain an optically shaped article having good dimensional accuracy by use of these compositions. In order to attain this effect, it is preferable that the content of the surface conditioner (e) is 0.005 to 3.0 parts by weight with respect to 100 parts by weight of the total amount of the composition for support material.

Examples of the surface conditioner (e) include silicone-based compounds. Examples of the silicone-based compounds include silicone-based compounds having a polydimethylsiloxane structure. Specific examples include polyether-modified polydimethylsiloxane, polyester-modified polydimethylsiloxane, and polyaralkyl-modified polydimethylsiloxane. As these, BYK-300, BYK-302, BYK-306, BYK-307, BYK-310, BYK-315, BYK-320, BYK-322, BYK-323, BYK-325, BYK-330, BYK-331, BYK-333, BYK-337, BYK-344, BYK-370, BYK-375, BYK-377, BYK-UV3500, BYK-UV3510, and BYK-UV3570 of trade names (all manufactured by BYK), TEGO-Rad 2100, TEGO-Rad 2200N, TEGO-Rad 2250, TEGO-Rad 2300, TEGO-Rad 2500, TEGO-Rad 2600, and TEGO-Rad 2700 of trade names (all manufactured by Evonik Industries AG), and GRANOL 100, GRANOL 115, GRANOL 400, GRANOL 410, GRANOL 435, GRANOL 440, GRANOL 450, B-1484, POLYFLOW ATF-2, KL-600, UCR-L72, and UCR-L93 of trade names (all manufactured by KYOEISHA CHEMICAL CO., LTD.) may be used. These may be used singly, or two or more thereof may be used concurrently. Incidentally, the content Is the sum of contents of the respective components (e) in a case in which two or more surface conditioners (e) are contained.

<Storage Stabilizer (f)>

The composition for support material contained in the optical shaping ink set according to the present embodiment further comprises a storage stabilizer (f). The storage stabilizer (f) can improve the storage stability of the composition. In addition, the storage stabilizer (f) can prevent head clogging caused by the polymerization of polymerizable compounds by thermal energy. In order to attain these effects, it is preferable that the content of the storage stabilizer (f) is preferably 0.05 to 3.0 parts by weight with respect to 100 parts by weight of the total amount of the composition for support material.

Examples of the storage stabilizer (f) include hindered amine-based compounds (HALS), phenol-based antioxidants, and phosphorus-based antioxidants. Specific examples include hydroquinone, methoquinone, benzoquinone, p-methoxyphenol, hydroquinone monomethyl ether, hydroquinone monobutyl ether, TEMPO, 4-hydroxy-TEMPO, TEMPOL, cupferron Al, IRGASTAB UV-10, IRGASTAB UV-22, FIRSTCURE ST-1 (manufactured by ALBEMARLE CORPORATION), t-butyl catechol, pyrogallol, and TINUVIN 111 FDL, TINUVIN 144, TINUVIN 292, TINUVIN XP40, TINUVIN XP60, and TINUVIN 400 manufactured by BASF. These may be used singly, or two or more thereof may be used concurrently. Incidentally, the content is the sum of contents of the respective components (f) in a case in which two or more storage stabilizers (f) are contained.

The composition for model material contained in the optical shaping ink set according to the present embodiment can comprise the other additives if necessary in the range in which the effect of the present invention is not inhibited. Examples of the other additives include an antioxidant, a coloring agent, an ultraviolet light absorber, a light stabilizer, a polymerization inhibitor, a chain transfer agent, and a filler.

The method for producing the composition for support material contained in the optical shaping ink set according to the present embodiment is not particularly limited. For example, the composition for support material can be produced by uniformly mixing the components (a) to (d) and, if necessary, the components (e) and (f) and the other additives using a mixing and stirring apparatus and the like.

It is preferable that the composition for support material produced in this manner has a viscosity of 70 mPa·s or less at 25° C. from the viewpoint of improving the dischargeability from the inkjet head. Incidentally, the measurement of the viscosity of the composition for support material is performed using R100 type viscometer in accordance with JIS Z 8803.

3. Optically Shaped Article and Method for Producing the Same

The optically shaped article according to the present embodiment is shaped using the optical shaping ink set according to the present embodiment. Specifically, the optically shaped article is produced by inkjet optical shaping method through a step (I) of photocuring the composition for model material described above to obtain a model material and, at the same time, photocuring the composition for support material described above to obtain a support material and a step (II) of removing the support material. The step (I) and the step (II) are not particularly limited but are performed, for example, by the following methods.

<Step (I)>

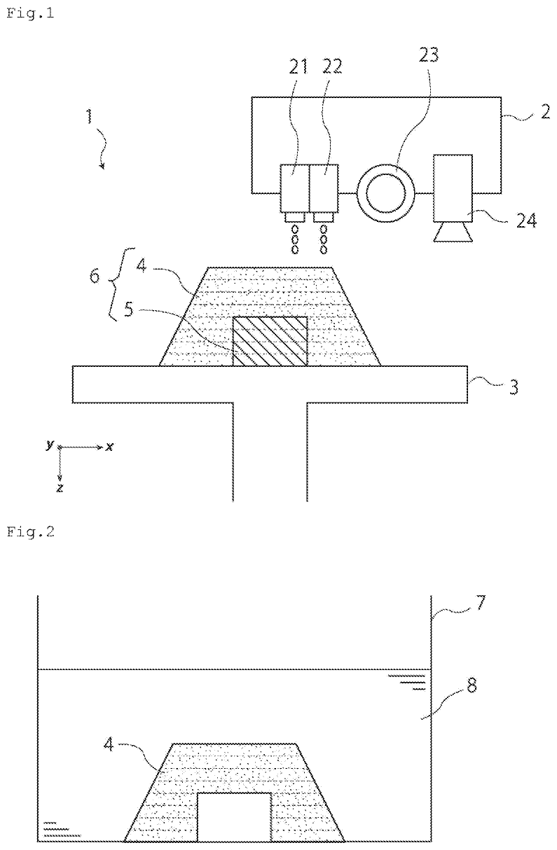

FIG. 1 is a diagram schematically illustrating the step (I) in the method for producing an optically shaped article according to the present embodiment. As illustrated in FIG. 1, a three-dimensional shaping apparatus 1 includes an inkjet head module 2 and a shaping table 3. The inkjet head module 2 includes an inkjet head for model material 21 filled with the composition for model material, an inkjet head for support material 22 filled with the composition for support material, a roller 23, and a light source 24.

First, the inkjet head module 2 is made to perform scanning in an X direction and a Y direction relatively to the shaping table 3 in FIG. 1, and at the same time, the composition for model material is discharged from the inkjet head for model material 21, and the composition for support material is discharged from the inkjet head for support material 22, and thereby, a composition layer composed of the composition for model material and the composition for support material is formed. In order to smooth an upper surface of the composition layer, the extra composition for model material and the extra composition for support material are removed using the roller 23. These compositions are irradiated with light using the light source 24, and thereby, a cured layer composed of a model material 4 and a support material 5 is formed on the shaping table 3.

Then, the shaping table 3 is lowered in a Z direction in FIG. 1 by the thickness of the cured layer. Thereafter, by the same method as that described above, a cured layer composed of a model material 4 and a support material 5 is further formed on the cured layer. By repeatedly performing these steps, a cured product 6 composed of a model material 4 and a support material 5 is prepared.

Examples of light for curing the composition include far infrared rays, infrared rays, visible rays, near ultraviolet rays, ultraviolet rays. From a viewpoint of easiness and efficiency of the curing work, among them, near ultraviolet rays or ultraviolet rays are preferable.

Examples of the light source 24 include a mercury lamp, a metal halide lamp, an ultraviolet LED, and an ultraviolet laser. Among these, from the viewpoint of miniaturization of facility and power saving, an ultraviolet LED is preferable. Incidentally, it is preferable that the integrated light quantity of the ultraviolet light is about 500 mJ/cm² in the case of using an ultraviolet LED as the light source 24.

<Step (II)>

FIG. 2 is a diagram schematically illustrating the step (II) in the method for producing an optically shaped article according to the present embodiment. As illustrated in FIG. 2, the cured product 6 composed of the model material 4 and the support material 5 prepared in the step (I) is immersed in a solvent 8 contained in a vessel 7. Thereby, the support material 5 can be dissolved in the solvent 8 and removed.

Examples of the solvent 8 for dissolving the support material include ion exchanged water, distilled water, tap water, and well water. Among these, ion exchanged water is preferable from the viewpoint of containing impurities in a relatively small amount and of being available at low cost.

The optically shaped article according to the present embodiment can be obtained through the above steps. As described above, by use of the optical shaping ink set according to the present embodiment, it is possible to obtain a model material which exhibits elongation and elasticity or a model material which is soft and excellent in tensile strength by photocuring the composition for model material contained in the optical shaping ink set. In addition, by use of the optical shaping ink set according to the present embodiment, it is possible to obtain a support material exhibiting excellent self-standing ability by photocuring the composition for support material contained in the optical shaping ink set. The optically shaped article produced using such a model material and such a support material has good dimensional accuracy.

Hereinafter, Examples which disclose the present embodiment more specifically will be described.

Incidentally, the present invention is not limited only to these Examples.

### EXAMPLES

### (1) Ink Set According to Embodiment (1) of Present Invention

<Composition for Model Material>

(Production of Composition for Model Material)

Compositions for model material of Examples M1 to M5 according to Embodiment (1) of the present invention were produced by uniformly mixing the monofunctional ethylenically unsaturated monomer (A), the polyfunctional ethylenically unsaturated monomer (B), a photopolymerization initiator, and a polymerization inhibitor at the proportions shown in Table 1 using a mixing and stirring apparatus.

TABLE 1

| | | | Hydroxyl | | | | | |
|---|---|---|---|---|---|---|---|---|
| | | | group/amino | Example | | | | |
| Composition for model material | | | group | M1 | M2 | M3 | M4 | M5 |
| Proportion (g) | Monofunctional | Genomer1122 | Amino group | 11.0 | 9.2 | 10.1 | — | — |
| | ethylenically | NIPAM | Amino group | — | — | — | 6.1 | — |
| | unsaturated monomer | Hydroxypropyl | Hydroxyl | — | — | — | — | 7.0 |
| | (A) | A | group | | | | | |
| | | Phenoxyethyl | — | 85.6 | — | — | 90.5 | 89.6 |
| | | A | | | | | | |
| | | Phenoxy DEGA | — | — | 87.8 | — | — | — |
| | | Isodecyl A | — | — | — | 86.7 | — | — |
| | Polyfunctional | HDDA | — | 1.7 | 1.5 | 1.6 | 1.8 | 1.8 |
| | ethylenically | | | | | | | |
| | unsaturated monomer | | | | | | | |
| | (B) | | | | | | | |
| | Photopolymerization | DAROCURE TPO | | 1.5 | 1.5 | 1.5 | 1.5 | 1.5 |
| | initiator | | | | | | | |
| | Polymerization | TEMPO | | 0.1 | 0.1 | 0.1 | 0.1 | 0.1 |
| | inhibitor | | | | | | | |

| | | | | | |
|---|---|---|---|---|---|
| Total molar fraction of hydroxyl group and | 10 | 10 | 10 | 10 | 10 |
| amino group (%) | | | | | |
| Molar fraction of (A) to (B) | 97/3 | 97/3 | 97/3 | 97/3 | 97/3 |

Genomer 1122: Urethane acrylate [genomer 1122 (ethylenic double bond/1 molecule: 1) manufactured by Rahn AG]

NIPAM: Isopropyl acrylamide [NIPAM (ethylenic double bond/I molecule: 1) manufactured by KOHJIN Film & Chemicals Co., Ltd.]

Hydroxypropyl A: Hydroxypropyl acrylate [LIGHT ESTER HOP-A (ethylenic double bond/l molecule: 1) manufactured by KYOEISHA CHEMICAL CO., LTD.]

Phenoxyethyl A: Phenoxyethyl acrylate [LIGHT ACRYLATE PO-A (ethylenic double bond/i molecule: 1) manufactured by KYOEISHA CHEMICAL CO., LTD.]

Phenoxy DEGA: Phenoxydiethylene glycol acrylate [LIGHT ACRYLATE P2H-A (ethylenic double bond/1 molecule: 1) manufactured by KYOEISHA CHEMICAL CO., LTD.]

Isodecyl A: Isodecyl acrylate [SR-395 (ethylenic double bond/1 molecule: 1) manufactured by Sartomer]

HDDA: 1,6-Hexanediol diacrylate [A-HD-N(ethylenic double bond/1 molecule: 2) manufactured by Shin-Nakamura Chemical Co., Ltd.]

DAROCURE TPO: 2,4,6-Trimethylbenzoyl-diphenyl-phosphine oxide [DAROCURE TPO manufactured by BASF]

TEMPO: 2,2,6,6-Tetramethylpiperidine-N-oxyl [TEMPO manufactured by Evonik Degussa Japan Co., Ltd.]

<Composition for Support Material>

(Production of Composition for Support Material)

Compositions for support material of Examples S1 to S4 and a composition for support material of Comparative Example s1 were produced by uniformly mixing the components (a) to (f) at the proportions shown in Table 2 using a mixing and stirring apparatus, and the following evaluations were performed using these compositions for support material.

TABLE 2

| | | | | | | | | Comparative |
|---|---|---|---|---|---|---|---|---|
| | | | | Example | | | | Example |
| Composition for support material | | | | S1 | S2 | S3 | S4 | s1 |
| Proportion | (a) | Water-soluble | HEAA | 25 | 25 | — | — | — |
| (Parts by weight) | | ethylenically | ACMO | — | — | 25 | — | — |
| | | unsaturated monomer | DMAA | — | — | — | 25 | 15* |
| | (b) | Polyalkylene glycol | PPG-400 | 45 | — | 45 | 45 | — |
| | | | PPG-1000 | — | 45 | — | — | 45 |
| | (c) | Water-soluble | MTG | 21.6 | 21.6 | 21.6 | 21.6 | 31.6 |
| | | organic solvent | | | | | | |
| | (d) | Photopolymerization | DAROCURE | 8 | 8 | 8 | 8 | 8 |
| | | initiator | TPO | | | | | |
| | (e) | Surface conditioner | TEGO-Rad2100 | 0.1 | 0.1 | 0.1 | 0.1 | 0.1 |
| | (f) | Storage stabilizer | H-TEMPO | 0.3 | 0.3 | 0.3 | 0.3 | 0.3 |

| | | | | | | |
|---|---|---|---|---|---|---|
| Evaluation | Viscosity (mPa · s) | ∘ | ∘ | ∘ | ∘ | ∘ |
| | Solubility in water | ∘ | ∘ | ∘ | ∘ | ∘ |
| | Oily exudation | ∘ | ∘ | ∘ | ∘ | ∘ |
| | Self-standing ability | ∘ | ∘ | ∘ | ∘ | x |

*means that the value is deviated from the range regulated in the present invention.

HEAA: N-hydroxyethyl acrylamide [HEAA (ethylenic double bond/1 molecule: 1) manufactured by KJ Chemicals Corporation]

ACMO: Acryloyl morpholine [ACMO (ethylenic double bond/1 molecule: 1) manufactured by KJ Chemicals Corporation]

DMAA: N,N′-Dimethyl acrylamide [DMAA (ethylenic double bond/1 molecule: 1) manufactured by KJ Chemicals Corporation]

PPG-400: Polypropylene glycol [UNIOL D400 (molecular weight: 400) manufactured by NOF CORPORATION]

PPG-1000: Polypropylene glycol [UNIOL D1000 (molecular weight: 1000) manufactured by NOF CORPORATION]

MTG: Triethylene glycol monomethyl ether [MTG manufactured by NIPPON NYUKAZAI CO., LTD.]

DAROCURE TPO: 2,4,6-Trimethylbenzoyl-diphenyl-phosphine oxide [DAROCURE TPO manufactured by BASF]

TEGO-Rad 2100: Silicon acrylate with polydimethylsiloxane structure [TEGO-Rad 2100 manufactured by Evonik Degussa Japan Co., Ltd.]

H-TEMPO: 4-Hydroxy-2,2,6,6-tetramethylpiperidine-N-oxyl [HYDROXY-TEMPO manufactured by Evonik Degussa Japan Co., Ltd.]

(Measurement of Viscosity)

The viscosity of each composition for support material was measured using a R100 type viscometer (manufactured by TOKI SANGYO CO., LTD.) under conditions of 25° C. and a cone rotation number of 5 rpm and was evaluated according to the following criteria. The evaluation results are shown in Table 2.

∘: Viscosity 70 mPa·s

x: Viscosity >70 mPa·s

(Solubility in Water)

In an aluminum cup having a diameter of 50 mm, 2.0 g of each composition for support material was sampled. Next, the composition for support material was irradiated with ultraviolet light and cured using an ultraviolet LED (NCCU 001E manufactured by NICHIA CORPORATION) as an irradiation unit so that the total irradiation light quantity was 500 mJ/cm² to obtain a support material. Thereafter, the support material was released from the aluminum cup. Subsequently, the support material was immersed in 500 ml of ion exchanged water contained in a beaker. The support material was visually observed every 10 minutes, the time required (hereinafter referred to as the time for dissolution in water) from the start of immersion to the complete dissolution or elimination of the original shape was measured, and the solubility was evaluated according to the following criteria. The evaluation results are shown in Table 2.

∘: Time for dissolution in water ≤1 hour

Δ: 1 Hour <time for dissolution in water <1.5 hours

x: Time for dissolution in water ≥1.5 hours

(Evaluation on Oily Exudation)

On an aluminum foil of 100 mm×100 mm, 1.0 g of each composition for support material was sampled. Next, the composition for support material was irradiated with ultraviolet light and cured using an ultraviolet LED (NCCU 001E manufactured by NICHIA CORPORATION) as an irradiation unit so that the total irradiation light quantity was 500 mJ/cm² to obtain a support material. Incidentally, the support material is in a solid state at this time point. This support material was left for 2 hours, and the presence or absence of exudation of the support material in an oil form on the surface was visually observed and evaluated according to the following criteria. The evaluation results are shown in Table 2.

∘: Oily exudation was not observed at all.

Δ: Oily exudation was slightly observed.

x: Oily exudation was remarkably observed.

(Evaluation on Self-Standing Ability)

The glass plate (trade name “GLASS PLATE” manufactured by AS ONE Corporation, 200 mm×200 mm×5 mm in thickness) used for the evaluation is a rectangle in plan view. Spacers having a thickness of 1 mm were disposed on the four sides of the upper surface of the glass plate to form a square region of 10 cm×10 cm. After each composition for support material was added in the region, another glass plate was superimposed thereon. Thereafter, the composition for support material was irradiated with ultraviolet light and cured using an ultraviolet LED (NCCU 001E manufactured by NICHIA CORPORATION) as an irradiation unit so that the total irradiation light quantity was 500 mJ/cm² to obtain a support material. Thereafter, the support material was released from the glass plate and cut into a shape of 10 mm long and 10 mm wide using a cutter to obtain a test piece. Next, 10 pieces of the test pieces were superimposed one on another to obtain a test piece group having a height of 10 mm. The test piece group was placed in an oven set at 30° C. in a state of being loaded with a weight of 100 g from the top and left for 1 hour. Thereafter, the shape of the test piece was observed, and the self-standing ability was evaluated according to the following criteria. The evaluation results are shown in Table 2.

∘: Shape was not changed.

Δ: Shape was slightly changed and weight was in inclined state.

x: Shape was remarkably changed.

As can be seen from the results in Table 2, the compositions for support material of Examples S1 to S4 satisfying all the requirements of the present invention had a viscosity suitable for discharging from the inkjet head. In addition, the support materials obtained by photocuring the compositions for support material of Examples S1 to S4 exhibited high solubility in water and suppressed oily exudation. Furthermore, the support materials obtained by photocuring the compositions for support material of S1 to S4 exhibited sufficient self-standing ability.

<Optically Shaped Article>

(Evaluation on Dimensional Accuracy of Optically Shaped Article)

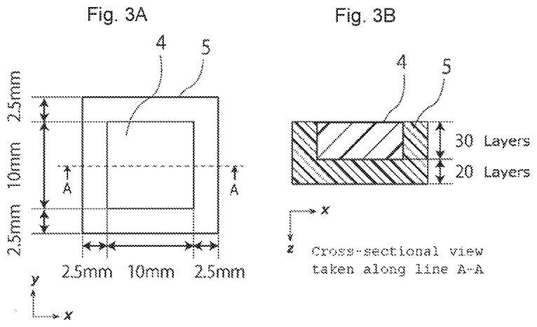

A cured product was produced using an optical shaping ink set prepared by combining each composition for model material shown in Table 1 and each composition for support material shown in Table 2. The shape and intended dimensions of the cured product are illustrated in FIGS. 3(a) and 3(b). Incidentally, the step of discharging each composition for model material and each composition for support material from the inkjet head was performed so that the resolution was 600×600 dpi and the thickness of one layer of the composition layer was about 13 to 14 μm. In addition, the step of respectively photocuring each composition for model material and each composition for support material was performed using an LED light source which had a wavelength of 385 nm and was installed behind the inkjet head with respect to the scanning direction under the conditions of an illuminance of 250 mW/cm² and an integrated light quantity of 300 mJ/cm² per one layer of the composition layer. Next, the support material was removed by immersing the cured product in ion exchanged water, thereby obtaining an optically shaped article. Thereafter, the optically shaped article obtained was left to still stand in a desiccator for 24 hours to be sufficiently dried. The optically shaped article was produced by five pieces for each through the steps described above. The dimensions of the optically shaped articles after drying in the x direction and y direction in FIG. 3(a) were measured using a caliper, and the rate of change from the intended dimension was calculated. The dimensional accuracy was evaluated according to the following criteria using the average value of the rate of change in dimension in each optically shaped article. The evaluation results are shown in Table 3.

∘: Average rate of change in dimension is less than ±1.0%

x: Average rate of change in dimension is ±1.0% or more

TABLE 3

| Evaluation on | | Composition for model material | | | | |
|---|---|---|---|---|---|---|
| dimensional accuracy | | M1 | M2 | M3 | M4 | M5 |
| Composition | S1 | ∘ | ∘ | ∘ | ∘ | ∘ |
| for | S2 | ∘ | ∘ | ∘ | ∘ | ∘ |
| support | S3 | ∘ | ∘ | ∘ | ∘ | ∘ |
| material | S4 | ∘ | ∘ | ∘ | ∘ | ∘ |
| | s1 | x | x | x | x | x |

As can be seen from the results in Table 3, it was possible to obtain optically shaped articles having good dimensional accuracy using the optical shaping ink sets comprising the compositions for model material of Examples M1 to M5 satisfying all the requirements of the present invention (according to Embodiment (1) of the present invention) and the compositions for support material of S1 to S4 satisfying all the requirements of the present invention in combination.

### (2) Ink Set According to Embodiment (2) of Present Invention

<Composition for Model Material>

(Production of Composition for Model Material)

Compositions for model material of Examples M1′ to M16′ according to Embodiment (2) of the present invention and compositions for model material of Comparative Examples m1′ to m3′ which do not accord to Embodiment (2) of the present invention were produced by uniformly mixing the ethylenically unsaturated monomer (C), the ethylenically unsaturated monomer (D), the bifunctional acrylate oligomer (E), an acyiphosphine oxide compound, a surfactant, and a storage stabilizer at the proportions shown in Tables 4 and 5 using a mixing and stirring apparatus.

TABLE 4

| Composition for | | | Example | | | | | | | |
|---|---|---|---|---|---|---|---|---|---|---|
| model material | | | M1′ | M2′ | M3′ | M4′ | M5′ | M6′ | M7′ | M8′ |
| Proportion | Ethylenically | IBOA | 15 | — | — | — | 15 | 15 | 15 | 15 |
| (parts by | unsaturated | TBCHA | — | 15 | — | — | — | — | — | — |
| weight) | monomer (C) | TMCHA | — | — | 15 | — | — | — | — | — |
| | Tg: 25° C. | DCPA | — | — | — | 15 | — | — | — | — |
| | to 120° C. | | | | | | | | | |
| | Ethylenically | PEA | 65 | 55 | 65 | 65 | — | — | — | — |
| | unsaturated | ST | — | — | — | — | 65 | — | — | — |
| | monomer (D) | IDA | — | — | — | — | — | 65 | — | — |
| | Tg: −60° | EOEOEA | — | — | — | — | — | — | 65 | — |
| | C. to lower | THFA | — | — | — | — | — | — | — | 65 |
| | than 25° C. | LA | — | — | — | — | — | — | — | — |
| | | NOAA | — | — | — | — | — | — | — | — |
| | | IOAA | — | — | — | — | — | — | — | — |
| | | NTDAA | — | — | — | — | — | — | — | — |
| | | INAA | — | — | — | — | — | — | — | — |
| | Bifunctional | CN996 | 10 | 10 | 10 | 10 | 10 | 10 | 10 | 10 |
| | acrylate | CN965 | — | — | — | — | — | — | — | — |
| | oligomer (E) | | | | | | | | | |
| | Acylphosphine | DAROCURE TPO | 5.8 | 5.8 | 5.8 | 5.8 | 5.8 | 5.8 | 5.8 | 5.8 |
| | oxide | IRGACURE819 | 4 | 4 | 4 | 4 | 4 | 4 | 4 | 4 |
| | compound | | | | | | | | | |
| | Surfactant | TEGO-Rad2100 | 0.1 | 0.1 | 0.1 | 0.1 | 0.1 | 0.1 | 0.1 | 0.1 |
| | Storage | IRGASUTAB UV-10 | 0.1 | 0.1 | 0.1 | 0.1 | 0.1 | 0.1 | 0.1 | 0.1 |
| | stabilizer | | | | | | | | | |
| Composition for | | | Example | | | | | | | |
| model material | | | M9′ | M10′ | M11′ | M12′ | M13′ | M14′ | M15′ | M16′ |
| Proportion | Ethylenically | IBOA | 15 | 15 | 15 | 15 | 15 | 15 | 15 | 15 |
| (parts by | unsaturated | TBCHA | — | — | — | — | — | — | — | — |
| weight) | monomer (C) | TMCHA | — | — | — | — | — | — | — | — |
| | Tg: 25° C. | DCPA | — | — | — | — | — | — | — | — |
| | to 120° C. | | | | | | | | | |
| | Ethylenically | PEA | — | — | — | — | — | — | — | — |
| | unsaturated | ST | — | — | — | — | — | 65 | 70 | 60 |
| | monomer (D) | IDA | — | — | — | — | — | — | — | — |
| | Tg: −60° C. | EOEOEA | — | — | — | — | — | — | — | — |
| | to lower | THFA | — | — | — | — | — | — | — | — |
| | than 25° C. | LA | 65 | — | — | — | — | — | — | — |
| | | NOAA | — | 65 | — | — | — | — | — | — |
| | | IOAA | — | — | 65 | — | — | — | — | — |
| | | NTDAA | — | — | — | 65 | — | — | — | — |
| | | INAA | — | — | — | — | 65 | — | — | — |
| | Bifunctional | CN996 | 10 | 10 | 10 | 10 | 10 | — | 5 | 15 |
| | acrylate | CN965 | — | — | — | — | — | 10 | — | — |
| | oligomer (E) | | | | | | | | | |
| | Acylphosphine | DAROCURE TPO | 5.8 | 5.8 | 5.8 | 5.8 | 5.8 | 5.8 | 5.8 | 5.8 |
| | oxide | IRGACURE819 | 4 | 4 | 4 | 4 | 4 | 4 | 4 | 4 |
| | compound | | | | | | | | | |
| | Surfactant | TEGO-Rad2100 | 0.1 | 0.1 | 0.1 | 0.1 | 0.1 | 0.1 | 0.1 | 0.1 |
| | Storage | IRGASUTAB UV-10 | 0.1 | 0.1 | 0.1 | 0.1 | 0.1 | 0.1 | 0.1 | 0.1 |
| | stabilizer | | | | | | | | | |

TABLE 5

| | | | Comparative Example | | |
|---|---|---|---|---|---|
| Composition for model material | | | m1′ | m2′ | m3′ |
| Proportion | Ethylenically | IBOA | 15 | —* | 20 |
| (parts by weight) | unsaturated monomer | TBCHA | 65 | —* | — |
| | (C) | TMCHA | — | —* | — |
| | Tg: 25° C. to 120° C. | DCPA | — | —* | — |
| | Ethylenically | PEA | —* | 15 | 70 |
| | unsaturated monomer | ST | —* | 65 | — |
| | (D) | IDA | —* | — | — |
| | Tg: −60° C. to lower | EOEOEA | —* | — | — |
| | than 25° C. | THFA | —* | — | — |
| | | LA | —* | — | — |
| | | NOAA | —* | — | — |
| | | IOAA | —* | — | — |
| | | NTDAA | —* | — | — |
| | | INAA | —* | — | — |
| | Bifunctional | CN996 | 10 | 10 | —* |
| | acrylate oligomer (E) | CN965 | — | — | —* |
| | Acylphosphine | DAROCURE TPO | 5.8 | 5.8 | 5.8 |
| | oxide compound | IRGACURE819 | 4 | 4 | 4 |
| | Surfactant | TEGO-Rad2100 | 0.1 | 0.1 | 0.1 |
| | Storage stabilizer | IRGASUTAB UV-10 | 0.1 | 0.1 | 0.1 |

*means that the value is deviated from the range regulated in the present invention.

IBOA: Isobornyl acrylate [Sartomer SR506D (ethylenic double bond/i molecule: 1, Tg: 94° C.) manufactured by ARKEMA]

TBCHA: t-Butyl cyclohexyl acrylate [Sartomer SR217 (ethylenic double bond/l molecule: 1, Tg: 20′C) manufactured by ARKEMA]

TMCHA: 3,5,5-Trimethylcyclohexyl acrylate [Sartomer SR420 (ethylenic double bond/1 molecule: 1, Tg: 27° C.) manufactured by ARKEMA]

DCPA: Dicyclopentanyl acrylate [FANCRYL FA-513AS (ethylenic double bond/1 molecule: 1, Tg: 120° C.) manufactured by Hitachi Chemical Co., Ltd.]

PEA: 2-Phenoxyethyl acrylate [Sartomer SR339A (ethylenic double bond/l molecule: 1, Tg: 5° C.) manufactured by ARKEMA]

ST: Stearyl acrylate [Sartomer SR257 (ethylenic double bond/1 molecule: 1, Tg: 9° C.) manufactured by ARKEMA]

IDA: Isodecyl acrylate [Sartomer SR395 (ethylenic double bond/1 molecule: 1, Tg: −60° C.) manufactured by ARKEMA]

EOEOEA: ethoxyethoxyethyl acrylate [Sartomer SR256 (ethylenic double bond/1 molecule: 1, Tg: −54° C.) manufactured by ARKEMA]

THFA: Tetrahydrofurfuryl acrylate [Sartomer SR285 (ethylenic double bond/i molecule: 1, Tg: −15° C.) manufactured by ARKEMA]

LA: Lauryl acrylate [Sartomer SR335 (ethylenic double bond/1 molecule: 1, Tg: −30° C.) manufactured by ARKEMA]

NOAA: n-Octyl acrylate [NOAA (ethylenic double bond/i molecule: 1, Tg: −65° C.) manufactured by OSAKA ORGANIC CHEMICAL INDUSTRY LTD.]

IOAA: Isooctyl acrylate [Sartomer SR440 (ethylenic double bond/1 molecule: 1, Tg: −54° C.) manufactured by ARKEMA]

NTDAA: n-Tridecyl acrylate [Sartomer SR489 (ethylenic double bond/l molecule: 1, Tg: −55° C.) manufactured by ARKEMA]

INAA: Isononyl acrylate [INAA (ethylenic double bond/1 molecule: 1, Tg: −58° C.) manufactured by OSAKA ORGANIC CHEMICAL INDUSTRY LTD.]

CN 996: Urethane acrylate oligomer [CN 996 (ethylenic double bond/1 molecule: 2, Mw: 2,850, Young's modulus: 21 MPa) manufactured by ARKEMA]

CN 965: Urethane acrylate oligomer [CN 995 (ethylenic double bond/i molecule: 2, Mw: 5,600, Young's modulus: 78 MPa) manufactured by ARKEMA]

DAROCURE TPO: 2,4,6-Trimethylbenzoyl-diphenyl-phosphine oxide [DAROCURE TPO manufactured by BASF SE]

IRGACURE 819: Bis(2,4,6-trimethylbenzoyl)-diphenyl-phosphine oxide [IRGACURE 819 manufactured by BASF]

TEGO-Rad 2100: Silicon acrylate with polydimethylsiloxane structure [TEGO-Rad 2100 manufactured by Evonik Industries AG]

IRGASUTAB UV-10: Bis(l-oxyl-2,2,6,6-tetramethylpiperidin-4-yl) sebacate [IRGASUTAB UV-10 manufactured by BASF]

<Composition for Support Material>

(Production of Composition for Support Material)

Compositions for support material of Examples S1′ to S17′ and compositions for support material of Comparative Example s1′ to s6′ were produced by uniformly mixing the components (a) to (f) at the proportions shown in Tables 6 and 7 using a mixing and stirring apparatus, and the viscosity, solubility in water, oily exudation, and self-standing ability were evaluated using these compositions for support material. Incidentally, the respective evaluation methods and evaluation criteria are the same methods and evaluation criteria as those in the evaluation of the composition for support material of Example S1 and the like in the ink set according to Embodiment (1) of the present invention. The results are shown in Tables 6 and 7.

Incidentally, in the present Examples, the compositions for support material were cured using an ultraviolet LED as an irradiation unit as to be described later. With regard to the composition for support material of Example S17′ (Reference Example), the content of the photopolymerization initiator (d) exceeded 20 parts by weight and thus the photopolymerization initiator (d) was not sufficiently dissolved but remained as a residue. Hence, the composition for support material of Example S17′ was not subjected to all the following evaluations. Incidentally, the composition for support material of Example S17′ was sufficiently cured when being irradiated with an ultraviolet LED in a state in which the undissolved photopolymerization initiator (d) existed.

TABLE 6

| | | | | Example | | | | | | | | |
|---|---|---|---|---|---|---|---|---|---|---|---|---|
| Composition for support material | | | | S1′ | S2′ | S3′ | S4′ | S5′ | S6′ | S7′ | S8′ | S9′ |
| Proportion | (a) | Water-soluble | HEAA | 25 | 25 | 25 | 25 | 25 | — | — | — | — |
| (parts by weight) | | ethylenically | ACMO | — | — | — | — | — | 25 | — | 20 | 50 |
| | | unsaturated | DMAA | — | — | — | — | — | — | 25 | — | — |
| | | monomer | | | | | | | | | | |
| | (b) | Polyalkylene | PPG-400 | 45 | — | — | — | — | — | — | — | — |
| | | glycol | PPG-1000 | — | 45 | — | — | 45 | 45 | 45 | 45 | 30 |
| | | containing | PEG-400 | — | — | 45 | — | — | — | — | — | — |
| | | oxyethylene | PEG-1000 | — | — | — | 45 | — | — | — | — | — |
| | | group and/or | | | | | | | | | | |
| | | oxypropylene | | | | | | | | | | |
| | | group | | | | | | | | | | |
| | (c) | Water-soluble | MTG | 21.6 | 21.6 | 21.6 | 21.6 | — | 21.6 | 21.6 | 21.6 | 11.6 |
| | | organic solvent | DPMA | — | — | — | — | 21.6 | — | — | — | — |
| | (d) | Photopolymerization | DAROCURE TPO | 8 | 8 | 8 | 8 | 8 | 8 | 8 | 8 | 8 |
| | | initiator | | | | | | | | | | |
| | (e) | Surface | TEGO-Rad2100 | 0.1 | 0.1 | 0.1 | 0.1 | 0.1 | 0.1 | 0.1 | 0.1 | 0.1 |
| | | conditioner | | | | | | | | | | |
| | (f) | Storage | H-TEMPO | 0.3 | 0.3 | 0.3 | 0.3 | 0.3 | 0.3 | 0.3 | 0.3 | 0.3 |
| | | stabilizer | | | | | | | | | | |

| | | | | | | | | | | |
|---|---|---|---|---|---|---|---|---|---|---|
| Evaluation | Viscosity (mPa · s) | ◯ | ◯ | ◯ | ◯ | ◯ | ◯ | ◯ | ◯ | ◯ |
| | Solubility in water | ◯ | ◯ | ◯ | ◯ | ◯ | ◯ | ◯ | ◯ | Δ |
| | Oily exudation | ◯ | ◯ | ◯ | ◯ | ◯ | ◯ | ◯ | ◯ | ◯ |
| | Self-standing ability | ◯ | ◯ | ◯ | ◯ | ◯ | ◯ | ◯ | Δ | ◯ |

| | | | | Example | | | | | | | |
|---|---|---|---|---|---|---|---|---|---|---|---|
| Composition for support material | | | | S10′ | S11′ | S12′ | S13′ | S14′ | S15′ | S16′ | S17′ |
| Proportion | (a) | Water-soluble | HEAA | — | — | — | — | — | — | — | — |
| (parts by weight) | | ethylenically | ACMO | 41.6 | 30 | 40 | 21 | 25 | 25 | 25 | 25 |
| | | unsaturated | DMAA | — | — | — | — | — | — | — | — |
| | | monomer | | | | | | | | | |
| | (b) | Polyalkylene | PPG-400 | — | — | — | — | — | — | — | — |
| | | glycol | PPG-1000 | 45 | 26.6 | 20 | 49 | 45 | 33 | 45 | 35 |
| | | containing | PEG-400 | — | — | — | — | — | — | — | — |
| | | oxyethylene | PEG-1000 | — | — | — | — | — | — | — | — |
| | | group and/or | | | | | | | | | |
| | | oxypropylene | | | | | | | | | |
| | | group | | | | | | | | | |
| | (c) | Water-soluble | MTG | 5 | 35 | 31.6 | 21.6 | 24.6 | 21.6 | 26.6 | 14.6 |
| | | organic solvent | DPMA | — | — | — | — | — | — | — | — |
| | (d) | Photopolymerization | DAROCURE TPO | 8 | 8 | 8 | 8 | 5 | 20 | 3 | 25 |
| | | initiator | | | | | | | | | |
| | (e) | Surface | TEGO-Rad2100 | 0.1 | 0.1 | 0.1 | 0.1 | 0.1 | 0.1 | 0.1 | 0.1 |
| | | conditioner | | | | | | | | | |
| | (f) | Storage | H-TEMPO | 0.3 | 0.3 | 0.3 | 0.3 | 0.3 | 0.3 | 0.3 | 0.3 |
| | | stabilizer | | | | | | | | | |

| | | | | | | | | | |
|---|---|---|---|---|---|---|---|---|---|
| Evaluation | Viscosity (mPa · s) | ◯ | ◯ | ◯ | ◯ | ◯ | ◯ | ◯ | — |
| | Solubility in water | ◯ | ◯ | Δ | ◯ | ◯ | ◯ | ◯ | — |
| | Oily exudation | ◯ | Δ | ◯ | Δ | ◯ | ◯ | ◯ | — |
| | Self-standing ability | ◯ | ◯ | ◯ | Δ | ◯ | ◯ | X | — |

TABLE 7

| | | | | Comparative Example | | | | | |
|---|---|---|---|---|---|---|---|---|---|
| Composition for support material | | | | s1′ | s2′ | s3′ | s4′ | s5′ | s6′ |
| Proportion | (a) | Water-soluble | HEAA | — | — | — | — | — | — |
| (parts by weight) | | ethylenically | ACMO | 15* | 55* | 40 | 25 | 40 | 20 |
| | | unsaturated monomer | DMAA | — | — | — | — | — | — |
| | (b) | Polyalkylene glycol | PPG-400 | — | — | — | — | — | — |
| | | containing | PPG-1000 | 45 | 25 | 51.6* | 26.6 | 15* | 55* |
| | | oxyethylene group | PEG-400 | — | — | — | — | — | — |
| | | and/or oxypropylene | PEG-1000 | — | — | — | — | — | — |
| | | group | | | | | | | |
| | (C) | Water-soluble | MTG | 31.6 | 11.6 | — | 40* | 36.6* | 16.6 |
| | | organic solvent | DPMA | — | — | — | — | — | — |
| | (d) | Photopolymerization | DAROCURE TPO | 8 | 8 | 8 | 8 | 8 | 8 |
| | | initiator | | | | | | | |
| | (e) | Surface conditioner | TEGO-Rad2100 | 0.1 | 0.1 | 0.1 | 0.1 | 0.1 | 0.1 |
| | (f) | Storage stabilizer | H-TEMPO | 0.3 | 0.3 | 0.3 | 0.3 | 0.3 | 0.3 |

| | | | | | | | |
|---|---|---|---|---|---|---|---|
| Evaluation | Viscosity (mPa · s) | ∘ | ∘ | x | ∘ | ∘ | x |
| | Solubility in water | ∘ | x | ∘ | ∘ | x | ∘ |
| | Oily exudation | ∘ | ∘ | Δ | x | x | x |
| | Self-standing ability | x | ∘ | ∘ | ∘ | ∘ | ∘ |

*means that the value is deviated from the range regulated in the present invention.

HEAA: N-hydroxyethyl acrylamide [HEAA (ethylenic double bond/1 molecule: 1) manufactured by KJ Chemicals Corporation]

ACMO: Acryloyl morpholine [ACMO (ethylenic double bond/1 molecule: 1) manufactured by KJ Chemicals Corporation]

DMAA: N,N′-Dimethyl acrylamide [DMAA (ethylenic double bond/1 molecule: 1) manufactured by KJ Chemicals Corporation]

PPG-400: Polypropylene glycol [UNIOL D400 (molecular weight: 400) manufactured by NOF CORPORATION]

PPG-1000: Polypropylene glycol [UNIOL D1000 (molecular weight: 1000) manufactured by NOF CORPORATION]

PEG-400: Polyethylene glycol [PEG #400 (molecular weight: 400) manufactured by NOF CORPORATION]

PEG-1000: Polyethylene glycol [PEG #1000 (molecular weight: 1000) manufactured by NOF CORPORATION]

MTG: Triethylene glycol monomethyl ether [MTG manufactured by NIPPON NYUKAZAI CO., LTD.]

DPMA: Dipropylene glycol monomethyl ether acetate [DAWANOL DPMA manufactured by The Dow Chemical Company]

DAROCURE TPO: 2,4,6-Trimethylbenzoyl-diphenyl-phosphine oxide [DAROCURE TPO manufactured by BASF]

TEGO-Rad 2100: Silicon acrylate with polydimethylsiloxane structure [TEGO-Rad 2100 manufactured by Evonik Degussa Japan Co., Ltd.]

H-TEMPO: 4-Hydroxy-2,2,6,6-tetramethylpiperidine-N-oxyl [HYDROXY-TEMPO manufactured by Evonik Dequssa Japan Co., Ltd.]

As can be seen from the results in Tables 6 and 7, the compositions for support material of Examples S1′ to S16′ satisfying all the requirements of the present invention had a viscosity suitable for discharging from the inkjet head. In addition, the support materials obtained by photocuring the compositions for support material of Examples S1′ to S16′ exhibited high solubility in water and suppressed oily exudation. Furthermore, the support materials obtained by photocuring the compositions for support material of S1′ to S15′ exhibited sufficient self-standing ability. Incidentally, a radical reaction was not promoted even when the composition for support material of Example S16′ (Reference Example) was irradiated with an ultraviolet LED since the content of the photopolymerization initiator (d) was less than 3 parts by weight, and the self-standing ability of the support material obtained was not sufficient. In the case of using a mercury lamp or a metal halide lamp as an irradiation unit, the support material obtained from the composition for support material of Example S16′ exhibits sufficient self-standing ability even when the content of the photopolymerization initiator (d) is 3 parts by weight.

Furthermore, the support materials obtained from the compositions for support material of Examples S1′ to S8′, S10′, S11′, and S13′ to S16′ in which the content of the water-soluble monofunctional ethylenically unsaturated monomer (a) was 45 parts by weight or less and the content of the polyalkylene glycol (b) containing an oxyethylene group and/or an oxypropylene group was 25 parts by weight or more exhibited higher solubility in water. The support materials obtained from the compositions for support material of Examples S1′ to S10′ and 514′ to S16′ in which the content of the polyalkylene glycol (b) containing an oxyethylene group and/or an exypropylene group was 45 parts by weight or less and the content of the water-soluble organic solvent (c) was 30 parts by weight or less exhibited more suppressed oily exudation. The support materials obtained from the compositions for support material of Examples S1′ to S7′, S9′ to S12′, S14′, and S15′ in which the content of the water-soluble monofunctional ethylenically unsaturated monomer (a) was 25 parts by weight or more exhibited more sufficient self-standing ability.

On the other hand, in the composition for support material of Comparative Example s1′, the content of the water-soluble monofunctional ethylenically unsaturated monomer (a) was less than 20 parts by weight, and thus the self-standing ability of the support material was not sufficient. In the composition for support material of Comparative Example s2′, the content of the water-soluble monofunctional ethylenically unsaturated monomer (a) exceeded 50 parts by weight, and thus the solubility of the support material in water was low. In the composition for support material of Comparative Example s3′, the content of the polyalkylene glycol (b) containing an oxyethylene group and/or an oxypropylene group exceeded 49 parts by weight, and thus the viscosity of the composition for support material was high and exudation of the support material in oil form occurred. In the composition for support material of Comparative Example s4′, the content of the water-soluble organic solvent (c) exceeded 35 parts by weight, and thus exudation of the support material in oil form occurred. In the composition for support material of Comparative Example s5′, the content of the polyalkylene glycol (b) containing an oxyethylene group and/or an oxypropylene group was less than 20 parts by weight, and thus the solubility of the support material in water was low. In addition, in the composition for support material of Comparative Example s5′, the content of the water-soluble organic solvent (c) exceeded 35 parts by weight, and thus exudation of the support material in oil form occurred. In the composition for support material of Comparative Example s6′, the content of the polyalkylene glycol (b) containing an oxyethylene group and/or an oxypropylene group exceeded 49 parts by weight, and thus the viscosity of the composition for support material was high and exudation of the support material in oil form occurred.

<Optically Shaped Article>

(Evaluation on Dimensional Accuracy of Optically Shaped Article)

Optically shaped articles of Test Nos. 1 to 10 were produced by five pieces for each using the ink sets for stereolithography comprising the respective compositions for model material shown in Tables 4 and 5 and the compositions for support material shown in Tables 6 and 7 by the same method as that for the fabrication of the cured products (optically shaped articles) using the ink set according to Embodiment (1) of the present invention described above. The optically shaped articles were evaluated by the same methods and evaluation criteria as those for the optically shaped articles produced using the ink set according to Embodiment (1) of the present invention. The evaluation results are shown in Table 8.

TABLE 8

| | Optically shaped article | | | | | | | | | |
|---|---|---|---|---|---|---|---|---|---|---|
| | Test No. | | | | | | | | | |
| | 1 | 2 | 3 | 4 | 5 | 6 | 7 | 8 | 9 | 10 |
| Composition | M1′ | M2′ | M3′ | M4′ | M5′ | M6′ | M7′ | m1′ | M1′ | m1′ |
| for model | | | | | | | | | | |
| material | | | | | | | | | | |
| Composition | S1′ | S2′ | S3′ | S4′ | S5′ | S6′ | S7′ | s5′ | s5′ | S1′ |
| for support | | | | | | | | | | |
| material | | | | | | | | | | |
| Dimensional | ∘ | ∘ | ∘ | ∘ | ∘ | ∘ | ∘ | x | x | x |
| accuracy | | | | | | | | | | |

As can be seen from the results in Table 8, the optically shaped articles of Test Nos. 1 to 7 produced using the optical shaping ink set satisfying all the requirements of the present invention (according to Embodiment (2) of the present invention) had good dimensional accuracy.

### INDUSTRIAL APPLICABILITY

The optical shaping ink set of the present invention can be suitably used when an optically shaped article having good dimensional accuracy is produced by inkjet optical shaping method.

### DESCRIPTION OF REFERENCE SIGNS

1: Three-dimensional shaping apparatus
2: Inkjet head module
3: Shaping table
4: Model material
5: Support material
6: Cured product
7: Vessel
8: Solvent
21: Inkjet head for model material
22: Inkjet head for support material
23: Roller
24: Light source

1. An optical shaping ink set, which is used in an inkjet optical shaping method, comprising a composition for model material used for shaping a model material in combination with a composition for support material used for shaping a support material,
wherein
the composition for model material comprises a monofunctional ethylenically unsaturated monomer (A) and a polyfunctional ethylenically unsaturated monomer (B),
the monofunctional ethylenically unsaturated monomer (A) contains a monofunctional ethylenically unsaturated monomer (A1) having a hydroxyl group or an amino group,
a total molar fraction of the hydroxyl group and the amino group is 5% to 30% with respect to a total amount of the monofunctional ethylenically unsaturated monomer (A) and the polyfunctional ethylenically unsaturated monomer (B), and
the composition for support material comprises, with respect to 100 parts by weight of the total amount of the composition for support material,
a water-soluble monofunctional ethylenically unsaturated monomer (a) at 20 to 50 parts by weight,
a polyalkylene glycol (b) containing an oxyethylene group and/or an oxypropylene group at 20 to 49 parts by weight,
a water-soluble organic solvent (c) at 35 parts by weight or less, and
a photopolymerization initiator (d).

2. The optical shaping ink set according to claim 1, wherein, in the composition for model material, a molar fraction of the monofunctional ethylenically unsaturated monomer (A) to the polyfunctional ethylenically unsaturated monomer (B) (monofunctional ethylenically unsaturated monomer (A)/polyfunctional ethylenically unsaturated monomer (B)) is 92/8 to 99.9/0.1.

3. The optical shaping ink set according to claim 1, wherein, in the composition for model material, at least either of the monofunctional ethylenically unsaturated monomer (A) or the polyfunctional ethylenically unsaturated monomer (B) has one or more selected from an amide bond, a urea bond, and a urethane bond.

4. The optical shaping ink set according to claim 1, wherein, in the composition for model material, the monofunctional ethylenically unsaturated monomer (A1) has a molecular weight of 200 to 1,000.

5. The optical shaping ink set according to claim 1, wherein, in the composition for model material, the polyfunctional ethylenically unsaturated monomer (B) contains a polyfunctional ethylenically unsaturated monomer (B1) having a hydroxyl group or an amino group, and the polyfunctional ethylenically unsaturated monomer (B1) has a molecular weight of 200 to 1,000.

6. An optical shaping ink set, which is used in an inkjet optical shaping method, comprising a composition for model material used for shaping a model material in combination with a composition for support material used for shaping a support material,
wherein
the composition for model material comprises:
an ethylenically unsaturated monomer (C) of which a homopolymer has a glass transition temperature of 25° C. or higher and 120° C. or lower,
an ethylenically unsaturated monomer (D) of which a homopolymer has a glass transition temperature of −65° C. or higher and lower than 25° C.,
a bifunctional acrylate oligomer (E) having a weight average molecular weight of 800 or more and 10,000 or less, and
an acylphosphine oxide compound,
a content of a bi- or higher functional acrylate compound is 15 parts by weight or less with respect to 100 parts by weight of the total amount of the composition for model material, and
a content of the bifunctional acrylate oligomer (E) is 1 to 15 parts by weight with respect to 100 parts by weight of the total amount of the composition for model material and
the composition for support material comprises, with respect to 100 parts by weight of the total amount of the composition for support material,
a water-soluble monofunctional ethylenically unsaturated monomer (a) at 20 to 50 parts by weight,
a polyalkylene glycol (b) containing an oxyethylene group and/or an oxypropylene group at 20 to 49 parts by weight,
a water-soluble organic solvent (c) at 35 parts by weight or less, and
a photopolymerization initiator (d).

7. The optical shaping ink set according to claim 6, wherein, in the composition for model material, the ethylenically unsaturated monomer (C) is a monofunctional ethylenically unsaturated monomer.

8. The optical shaping ink set according to claim 6, wherein, in the composition for model material, the ethylenically unsaturated monomer (D) is a monofunctional ethylenically unsaturated monomer.

9. The optical shaping ink set according to claim 6, wherein, in the composition for model material, the bifunctional acrylate oligomer (E) has a Young's modulus at 25° C. of 1 to 100 MPa.

10. (canceled)

11. The optical shaping ink set according to claim 6, wherein, in the composition for model material, the ethylenically unsaturated monomer (C) is one or more selected from isobornyl acrylate, t-butylcyclohexyl acrylate, 3,3,5-trimethylcyclohexyl acrylate, and dicyclopentanyl acrylate.

12. The optical shaping ink set according to claim 6, wherein, in the composition for model material, the ethylenically unsaturated monomer (D) is one or more selected from phenoxyethyl acrylate, n-stearyl acrylate, isodecyl acrylate, ethoxyethoxyethyl acrylate, tetrahydrofurfuryl acrylate, n-lauryl acrylate, n-octyl acrylate, n-decyl acrylate, isooctyl acrylate, n-tridecyl acrylate, and 2-(N-butylcarbamoyloxy)ethyl acrylate.

13. The optical shaping ink set according to claim 1, wherein a content of the water-soluble monofunctional ethylenically unsaturated monomer (a) in the composition for support material is 25 to 45 parts by weight with respect to 100 parts by weight of the total amount of the composition for support material.

14. The optical shaping ink set according to claim 1, wherein a content of the polyalkylene glycol (b) in the composition for support material is 25 to 45 parts by weight with respect to 100 parts by weight of the total amount of the composition for support material.

15. The optical shaping ink set according to claim 1, wherein a content of the water-soluble organic solvent (c) in the composition for support material is 5 parts by weight or more with respect to 100 parts by weight of the total amount of the composition for support material.

16. The optical shaping ink set according to claim 1, wherein a content of the photopolymerization initiator (d) in the composition for support material is 5 to 20 parts by weight with respect to 100 parts by weight of the total amount of the composition for support material.

17. The optical shaping ink set according to claim 1, wherein the composition for support material further comprises a storage stabilizer (e) at 0.05 to 3.0 parts by weight with respect to 100 parts by weight of the total amount of the composition for support material.

18. An optically shaped article shaped by an inkjet optical shaping method using the optical shaping ink set according to claim 1.

19. A method for producing an optically shaped article by an inkjet optical shaping method using the optical shaping ink set according to claim 1, the method comprising:
a step (I) of photocuring the composition for model material to obtain a model material and, at the same time, photocuring the composition for support material to obtain a support material; and
a step (II) of removing the support material.

20. The method for producing an optically shaped article according to claim 19, wherein the composition for model material and the composition for support material are photocured using an ultraviolet LED in the step (I).

21. The optical shaping ink set according to claim 1, wherein the water-soluble monofunctional ethylenically unsaturated monomer (a) consists of one or more selected from the group consisting of hydroxyl group-containing (meth)acrylates having 2 to 15 carbon atoms, alkylene oxide adduct-containing (meth)acrylates having an Mn of 200 to 1,000, (meth)acrylamide, N-methyl (meth)acrylamide, N-ethyl (meth)acrylamide, N-propyl (meth)acrylamide, N-butyl (meth)acrylamide, N,N′-dimethyl (meth)acrylamide, N,N′-diethyl (meth)acrylamide, N-hydroxyethyl (meth)acrylamide, N-hydroxypropyl (meth)acrylamide, N-hydroxybutyl (meth)acrylamide, and (meth)acryloyl morpholine.

22. The optical shaping ink set according to claim 6, wherein the water-soluble monofunctional ethylenically unsaturated monomer (a) consists of one or more selected from the group consisting of hydroxyl group-containing (meth)acrylates having 2 to 15 carbon atoms, alkylene oxide adduct-containing (meth)acrylates having an Mn of 200 to 1,000, (meth)acrylamide, N-methyl (meth)acrylamide, N-ethyl (meth)acrylamide, N-propyl (meth)acrylamide, N-butyl (meth)acrylamide, N,N′-dimethyl (meth)acrylamide, N,N′-diethyl (meth)acrylamide, N-hydroxyethyl (meth)acrylamide, N-hydroxypropyl (meth)acrylamide, N-hydroxybutyl (meth)acrylamide, and (meth)acryloyl morpholine.

23. The optical shaping ink set according to claim 6, wherein a content of the water-soluble monofunctional ethylenically unsaturated monomer (a) in the composition for support material is 25 to 45 parts by weight with respect to 100 parts by weight of the total amount of the composition for support material.

24. The optical shaping ink set according to claim 6, wherein a content of the polyalkylene glycol (b) in the composition for support material is 25 to 45 parts by weight with respect to 100 parts by weight of the total amount of the composition for support material.

25. The optical shaping ink set according to claim 6, wherein a content of the water-soluble organic solvent (c) in the composition for support material is 5 parts by weight or more with respect to 100 parts by weight of the total amount of the composition for support material.

26. The optical shaping ink set according to claim 6, wherein a content of the photopolymerization initiator (d) in the composition for support material is 5 to 20 parts by weight with respect to 100 parts by weight of the total amount of the composition for support material.

27. The optical shaping ink set according to claim 6, wherein the composition for support material further comprises a storage stabilizer (e) at 0.05 to 3.0 parts by weight with respect to 100 parts by weight of the total amount of the composition for support material.

28. An optically shaped article shaped by an inkjet optical shaping method using the optical shaping ink set according to claim 6.

29. A method for producing an optically shaped article by an inkjet optical shaping method using the optical shaping ink set according to claim 6, the method comprising:
a step (I) of photocuring the composition for model material to obtain a model material and, at the same time, photocuring the composition for support material to obtain a support material; and
a step (II) of removing the support material.
